(19) United States
(12) Patent Application Publication
(10) Pub. No.: US 2025/0217106 A1
(43) Pub. Date: Jul. 3, 2025

(54) COMPUTE-IN-MEMORY DEVICES AND METHODS FOR OPERATING THE SAME

(71) Applicant: Taiwan Semiconductor Manufacturing Company, Ltd., Hsinchu (TW)

(72) Inventors: Haruki Mori, Hsinchu City (TW); Je-Min Hung, Hsinchu City (TW); Hidehiro Fujiwara, Hsinchu City (TW)

(73) Assignee: Taiwan Semiconductor Manufacturing Company, Ltd., Hsinchu (TW)

(21) Appl. No.: 18/642,256

(22) Filed: Apr. 22, 2024

Related U.S. Application Data
(60) Provisional application No. 63/616,934, filed on Jan. 2, 2024.

(51) Int. Cl. G06F 7/523; G06F 7/50

(52) U.S. Cl. CPC G06F 7/523; G06F 7/50

(57) ABSTRACT

A memory circuit includes a Booth encoder configured to receive a first data element including a first sign portion and a first data portion. The memory circuit includes a Booth decoder configured to receive a second data element including a second sign portion and a second data portion, and provide a product based on the first data element and the second data element. The memory circuit includes a plurality of multiplexers operatively coupled between the Booth encoder and the Booth decoder. The plurality of multiplexers are configured to receive a plurality of encoded signals from the Booth encoder and to change respective logic states of the plurality of encoded signals based on the first sign portion and the second sign portion, causing the Booth decoder to provide the product.

### CROSS-REFERENCE TO RELATED APPLICATION

This application claims priority to and the benefit of U.S. Provisional Application No. 63/616,934, filed Jan. 2, 2024, which is incorporated herein by reference in its entirety for all purposes.

### BACKGROUND

Computer artificial intelligence (AI) has been built on machine learning, for example, using deep learning techniques. With machine learning, a computing system organized as a neural network computes a statistical likelihood of a match of input data with prior computed data. A neural network refers to a number of interconnected processing nodes that enable the analysis of data to compare an input to “trained” data. Trained data refers to computational analysis of properties of known data to develop models to use to compare input data. An example of an application of AI and data training is found in object recognition, where a system analyzes the properties of many (e.g., thousands or more) of images to determine patterns that can be used to perform statistical analysis to identify an input object.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates an example block diagram of a compute-in-memory (CIM) circuit, in accordance with some embodiments.

FIG. 2 illustrates a block diagram of one of the computation blocks of the CIM circuit of FIG. 1, in accordance with some embodiments.

FIG. 3 illustrates a component block diagram illustrating Booth encoding of a data element for Booth multiplication, in accordance with some embodiments.

FIG. 4 illustrates a table summarizing Booth encoding of a data element for Booth multiplication, in accordance with some embodiments.

FIG. 5 illustrates a schematic diagram of an example implementation of the computation block of FIG. 1, in accordance with some embodiments.

FIG. 6 illustrates a table summarizing Booth encoding of a data element for Booth multiplication, in accordance with some embodiments.

FIG. 7 illustrates a circuit diagram of a sign-aware multiplexer of the computation block of FIG. 5, in accordance with some embodiments.

FIG. 8 illustrates a block diagram including a plural number of the computation blocks of FIG. 5, in accordance with some embodiments.

FIG. 9 illustrates a flow chart of an example method for operating the computation block of FIG. 5, in accordance with some embodiments.

FIG. 10 illustrates a schematic diagram of an example implementation of the computation circuit of FIG. 1, in accordance with some embodiments.

FIGS. 11, 12, 13, and 14 respectively illustrate different combinations of signed/unsigned data elements processed by the computation circuit of FIG. 10, in accordance with some embodiments.

FIG. 15 illustrates a flow chart of an example method for operating the computation circuit of FIG. 10, in accordance with some embodiments.

FIG. 16 illustrates different combinations of signed/unsigned data elements processed by the computation circuit of FIG. 10, in accordance with some embodiments.

FIG. 17 illustrates an example circuit diagram of a Booth encoder, in accordance with some embodiments.

FIG. 18 illustrates an example circuit diagram of a Booth decoder, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The terms “processor,” “processor core,” “controller,” and “control unit” are used interchangeably herein, unless otherwise noted, to refer to any one or all of a software-configured processor, a hardware-configured processor, a general purpose processor, a dedicated purpose processor, a single-core processor, a homogeneous multi-core processor, a heterogeneous multi-core processor, a core of a multi-core processor, a microprocessor, a central processing unit (CPU), a graphics processing unit (GPU), a digital signal processor (DSP), etc., a controller, a microcontroller, a field programmable gate array (FPGA), an application-specific integrated circuit (ASIC), other programmable logic devices, discrete gate logic, transistor logic, and the like. A processor may be an integrated circuit, which may be configured such that the components of the integrated circuit reside on a single piece of semiconductor material, such as silicon.

Neural networks compute “weights” to perform computation on new data (an input data “word”). Neural networks use multiple layers of computational nodes, where deeper layers perform computations based on results of computations performed by higher layers. Machine learning currently relies on the computation of dot-products and absolute difference of vectors, typically computed with multiply-accumulate (MAC) operations performed on the parameters, input data and weights. The computation of large and deep neural networks typically involves so many data elements, and thus it is not practical to store them in processor cache. Accordingly, these data elements are usually stored in a memory.

Thus, machine learning is very computationally intensive with the computation and comparison of many different data elements. The computation of operations within a processor is orders of magnitude faster than the transfer of data elements between the processor and main memory resources. Placing all the data elements closer to the processor in caches is prohibitively expensive for the great majority of practical systems due to the memory sizes needed to store the data elements. Thus, the transfer of data elements becomes a major bottleneck for AI computations. As the data sets increase, the time and power/energy a computing system uses for moving data elements around can end up being multiples of the time and power used to actually perform computations.

In this regard, compute-in-memory (CIM) circuits or systems have been proposed to perform such MAC operations. A CIM circuit instead conducts data processing in situ within a suitable memory circuit. The CIM circuit suppresses the latency for data/program fetch and output results upload in corresponding memory (e.g. a memory array), thus solving the memory (or von Neumann) bottleneck of conventional computers. Another key advantage of the CIM circuit is the high computing parallelism, thanks to the specific architecture of the memory array, where computation can take place along several current paths at the same time. The CIM circuit also benefits from the high density of multiple memory arrays with computational devices, which generally feature excellent scalability and the capability of 3D integration. As a non-limiting example, the CIM circuit targeted for various machine learning applications can perform the MAC operations locally within the memory (i.e., without having to send data elements to a host processor) to enable higher throughput dot-product of neuron activation and weight matrices, while still providing higher performance and lower energy compared to computation by the host processor.

Data elements, processed by the CIM circuit, have various data types or forms, such as an integer data type and a floating point data type. The integer data types, each of which represents a range of mathematical integers, may be of different sizes. For example, the integer data types are of 4 bits (sometimes referred to as an INT4 data type), 8 bits (sometimes referred to as an INT8 data type), etc. The floating point data type is typically represented by a sign portion, an exponent portion, and a significand (mantissa) portion that consists of the significant digits of the number. For example, one floating point number format specified by the Institute of Electrical and Electronics Engineers (IEEE®) has sixteen bits in size (sometimes referred to as an FP16 data type), which includes ten mantissa bits, five exponent bits, and one sign bit. Another floating point number format also has sixteen bits in size (sometimes referred to as a BF16 data type), which includes seven mantissa bits, eight exponent bits, and one sign bit.

In machine learning applications, the CIM circuit is frequently configured to process dot product multiplications based on performing MAC operations on a large number of data elements (e.g., an input word vector and a weight matrix), which may be in the floating point data type, and then process addition (or accumulation) of such dot products. Few CIM circuits have been proposed to process MAC operations on data elements provided in the floating point data type. For example, a Booth multiplier, which operate in parallel with multiple stages to produce a final product, has been proposed to integrate into a CIM circuit.

A Booth multiplier generally operates according to the principles of Booth's algorithm. The Booth's algorithm multiplies two signed binary numbers. As is typical in binary multiplication, the Booth's algorithm generates partial products of the multiplication of a multiplicand by a multiplier that are shifted and summed to produce a final product. The Booth's algorithm uses rules based on values of groups of bits of the multiplier to determine operations for generating the partial products using the multiplicand. To calculate a final product, after generating all partial products, the Booth multiplier typically shifts the partially products with respective bit(s) and outputs the shifted partial products to an adder tree for summing the shifted partial products.

While processing the data elements provided with a sign (sometimes referred to as signed data elements), the existing CIM circuit typically requires at least one 2's complement circuit operatively coupled between a corresponding Booth multiplier and a corresponding adder tree. For example, in the existing CIM circuit, the Booth multiplier generates partial products based on the respective unsigned portions of an input data element and a weight data element, and provides such partial products to the 2's complement circuit. The 2's complement circuit then determines whether to perform 2's complement conversion based on the respective sign portions of the input data element and weight data element. For example, if the input data element and weight data element have the same sign, the 2's complement circuit is deactivated to change a polarity of the partial products; and if the input data element and weight data element have different signs, the 2's complement circuit is activated to change the polarity of the partial products. Such a 2's complement circuit typically includes at least one additional half adder, which significantly complicates design of the CIM circuit and disadvantageously increases a size of the CIM circuit. Thus, the existing CIM circuits that adopt a Booth multiplier have not been entirely satisfactory in certain aspects.

The present disclosure provides various embodiments of a compute-in-memory (CIM) circuit configured to process a number of input data elements and a number of weight data elements. In one aspect, the CIM circuit, as disclosed herein, can perform in-memory computations (e.g., multiply-accumulate (MAC) operations) on an input data element and a weight data element that can each be provided with a sign (e.g., signed input data element and signed weight data element), without performing the above-mentioned 2's complement conversion. The disclosed CIM circuit can multiply the input data element by the weight data element based on a number of sign-aware Booth decoded values. For example, the CIM circuit may include a Booth encoder, a Booth decoder (sometimes referred to as a Booth multiplier), and a number of sign-aware multiplexers coupled between the Booth encoder and the Booth decoder. The Booth encoder can first generate a number of Booth encoded values based on the input data element (e.g., a mantissa portion of the input data element if being provided with a floating point data type). The sign-aware multiplexers can determine whether to directly forward the Booth encoded values to the Booth decoder (without inversing) or inverse the Booth encoded values and then provide the inversed Booth encoded values to the Booth decoder, based on an XOR'ed signal of respective sign portions of the input data element and the weight data element. Upon receiving such sign-aware decoded signals, the Booth decoder can multiply the decoded signals (representing the input data element) by the weight data element (e.g., a mantissa portion of the weight data element if being provided with a floating point data type) to generate a number of partial products to be summed for a final product.

In another aspect, the CIM circuit, as disclose herein, can perform MAC operations on the input data elements and the weight data elements that can each be provided with or without a sign. The disclosed CIM circuit can multiply the input data element by the weight data element with selectively performing sign extension based on whether the input/weight data elements are provided as signed or unsigned. As a representative example, if the input data element is provided as unsigned, the CIM circuit can determine not to perform sign extension on the input data element. Instead, the CIM circuit may append one or more additional “0” bits to the most significant bit of the input data element. If the input data element is provided as signed, the CIM circuit can determine to perform sign extension on the input data element. For example, the CIM circuit may include a Booth encoder, a Booth decoder (sometimes referred to as a Booth multiplier), and a number of logic gates. The Booth encoder can first generate a number of Booth encoded values based on the input data element, and provide the Booth encoded values to the Booth decoder. Further, some of the logic gates, coupled to the Booth decoder, can determine whether the input data element is provided as signed or unsigned. If signed, these logic gates can cause the CIM circuit to perform sign extension on the input data elements by appending additional bit(s) identical to the most significant bit of the input data element to the most significant bit of the input data element. If unsigned, these logic gates can cause the CIM circuit to not perform sign extension on the weight data elements by appending one or more “0” bits to the most significant bit of the input data element.

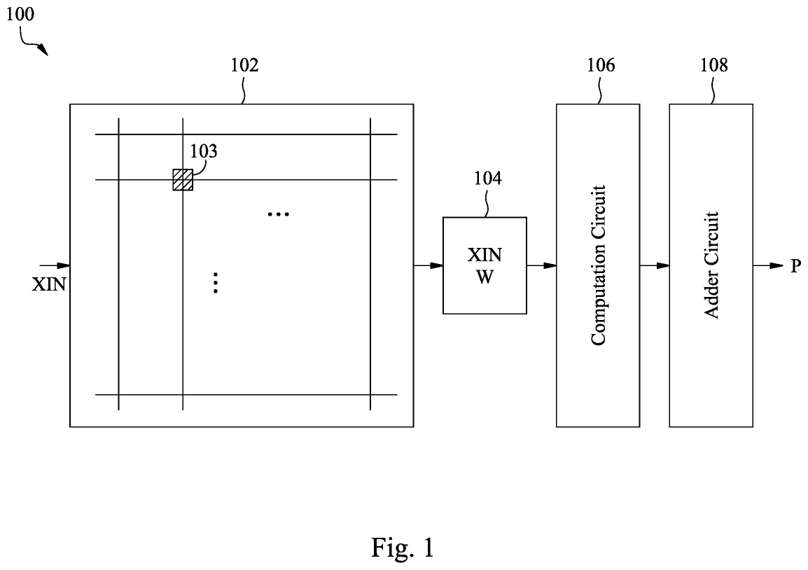

FIG. 1 illustrates a block diagram of a compute-in-memory (CIM) circuit 100, in accordance with various embodiments of the present disclosure. In the illustrated embodiment depicted in FIG. 1, the CIM circuit 100, also referred to as memory circuit 100, includes various components collectively configured to perform in-memory computations (e.g., multiply-accumulate (MAC) operations) on an input word vector and a weight matrix. The input word vector can include a plural number of input data elements XIN, and the weight matrix can include a plural number of weight data elements W.

In some embodiments, each of the input data elements XIN and the weight data elements W may be configured or provided in the INT8 data type. In some embodiments, each of the input data elements XIN and the weight data elements W may be configured or provided in the INT4 data type. In some embodiments, each of the input data elements XIN and the weight data elements W may be configured or provided in the FP16 data type. In some embodiments, each of the input data elements XIN and the weight data elements W may be configured or provided in the BF16 data type.

As shown, the CIM circuit 100 includes a memory circuit 102, an input circuit 104, a computation circuit 106, and an adder circuit (or adder tree) 108. Each of the components shown in FIG. 1 (e.g., 102 to 108) is an electronic circuit including logic circuitry configured to perform a respective function. In some embodiments, the computation circuit 106 can provide a number of partial products based on multiplying a multiplicand (e.g., the input data elements XIN) by a multiplier (e.g., the weight data elements W) using the Booth algorithm. It should be appreciated that the block diagram of the circuit depicted in FIG. 1 is simplified, and thus, the CIM circuit 100 can include any of various other components while remaining within the scope of the present disclosure.

The memory circuit 102 may include one or more memory arrays and one or more corresponding circuits. The memory arrays are each a storage device including a number of storage elements 103, each of the storage elements 103 including an electrical, electromechanical, electromagnetic, or other device configured to store one or more data elements, each data element including one or more data bits represented by logical states. In some embodiments, a logical state corresponds to a voltage level of an electrical charge stored in a portion or all of a storage element 103. In some embodiments, a logical state corresponds to a physical property, e.g., a resistance or magnetic orientation, of a portion or all of a storage element 103.

In some embodiments, the storage element 103 includes one or more static random-access memory (SRAM) cells. In various embodiments, an SRAM cell includes a number of transistors, e.g., a five-transistor (5T) SRAM cell, a six-transistor (6T) SRAM cell, an eight-transistor (8T) SRAM cell, a nine-transistor (9T) SRAM cell, etc. In some embodiments, the storage element 103 includes one or more dynamic random-access memory (DRAM) cells, resistive random-access memory (RRAM) cells, magnetoresistive random-access memory (MRAM) cells, ferroelectric random-access memory (FeRAM) cells, NOR flash cells, NAND flash cells, conductive-bridging random-access memory (CBRAM) cells, data registers, non-volatile memory (NVM) cells, 3D NVM cells, or other memory cell types capable of storing bit data.

In addition to the memory array(s), the memory circuit 102 can include a number of circuits to access or otherwise control the memory arrays. For example, the memory circuit 102 may include a number of (e.g., word line) drivers operatively coupled to the memory arrays. The drivers can apply signals (e.g., voltages) to the corresponding storage elements 103 so as to allow those storage elements 103 to be accessed (e.g., programmed, read, etc.). For another example, the memory circuit 102 may include a number of programming circuits and/or read circuits that are operatively coupled to the memory arrays.

The memory arrays of the memory circuit 102 are each configured to store a number of the weight data elements W. In some embodiments, the programming circuits may write the weight data elements W into corresponding storage elements 103 of the memory arrays, respectively, while the reading circuit may read bits written into the storage elements 103, so as to verify or otherwise test whether the written weight data elements W are correct. The drivers of the memory circuit 102 can include or be operatively coupled to a number of input activation latches that are configured to receive and temporarily store the input data elements XIN. In some other embodiments, such input activation latches may be part of the input circuit 104, which can further include a number of buffers that are configured to temporarily store the weight data elements W retrieved from the memory arrays of the memory circuit 102. As such, the input circuit 104 can receive the input data elements XIN and the weight data elements W.

In some embodiments, the input word vector (including, e.g., the input data elements XIN) and the weight matrix (including, e.g., the weight data elements W), on which the CIM circuit 100 is configured to perform MAC operations, can be configured in any of at least the following data types: the INT8 data type, the INT4 data type, the FP16 data type, and the BF16 data type. However, it should be understood that each of the input data elements XIN and the weight data elements W can have any of various other integer or floating point data types such as, for example, an INT16 data type, an UINT16 data type, an UINT8 data type, an UINT4 data type, a FP32 data type, a FP64 data type, a FP128 data type, etc., while remaining within the scope of the present disclosure.

When configured as the INT8 data type, each of the input data elements XIN and weight data elements W includes 8 bits, with the leftmost bit at its sign bit. When configured as the INT4 data type, each of the input data elements XIN and weight data elements W includes 4 bits, with the leftmost bit at its sign bit. When configured as the UINT8 data type, each of the input data elements XIN and weight data elements W includes 8 bits, with no bit representing a sign. When configured as the UINT4 data type, each of the input data elements XIN and weight data elements W includes 4 bits, with no bit representing a sign. When configured as the FP16 data type, each of the input data elements XIN and weight data elements W includes 1 sign bit, 5 exponent bits, and 10 mantissa bits. When configured as the BF16 data type, each of the input data elements XIN and weight data elements W includes 1 sign bit, 8 exponent bits, and 7 mantissa bits.

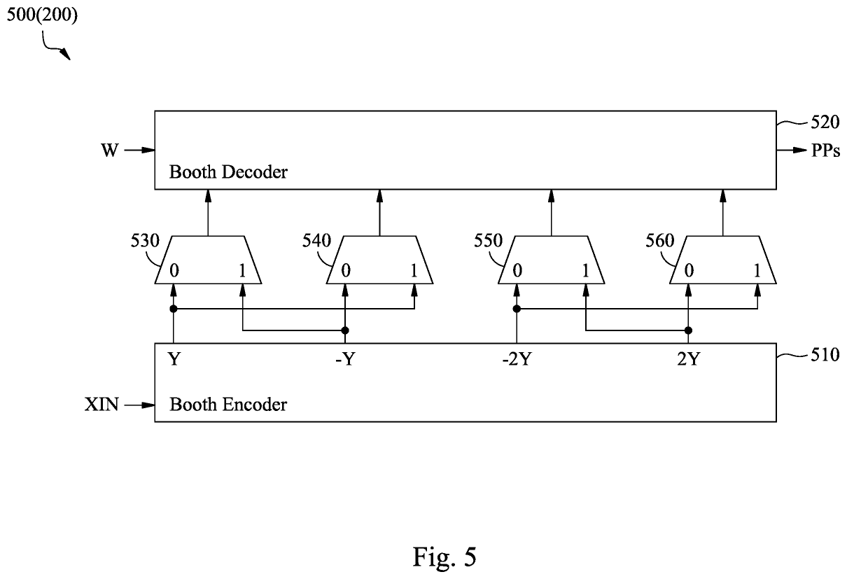

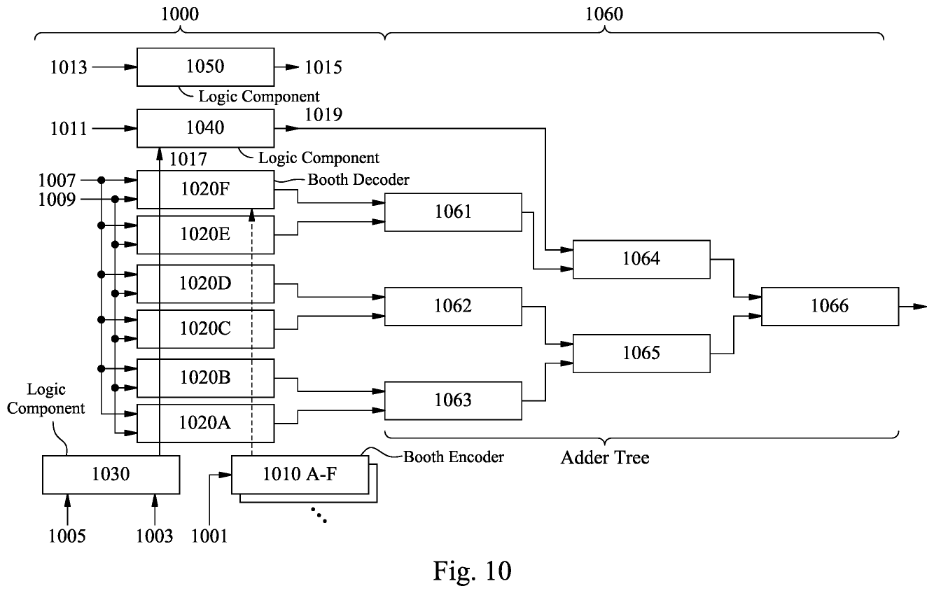

Referring still to FIG. 1, the input circuit 104 is configured to output entireties of the input data elements XIN and the weight data elements W to the computation circuit 106. In some embodiments of the present disclosure, the computation circuit 106 can include a number of computation blocks corresponding to a number of bits of the input data elements XIN. Each of the computation blocks can include a Booth encoder, a number of sign-aware multiplexers, and a Booth decoder collectively configured for generating at least one partial product, which will be discussed in further detail below with respect to FIG. 5. In some other embodiments of the present disclosure, the computation circuit 106 can include a number of Booth encoders and a corresponding number of Booth decoders. In such embodiments, the computation circuit 106 can further include a number of logic gates configured to process the input data elements XIN and the weight data elements W, regardless of being provided as signed or unsinged, so as to determine whether to perform sign extension on the weight data elements W and/or the input data elements XIN. Details of such embodiments will be discussed below with respect to FIG. 10. The adder tree 108 can receive the partial products from the computation circuit 106, and sum them up to generate a final product (P) of the input data elements XIN and the weight data elements W.

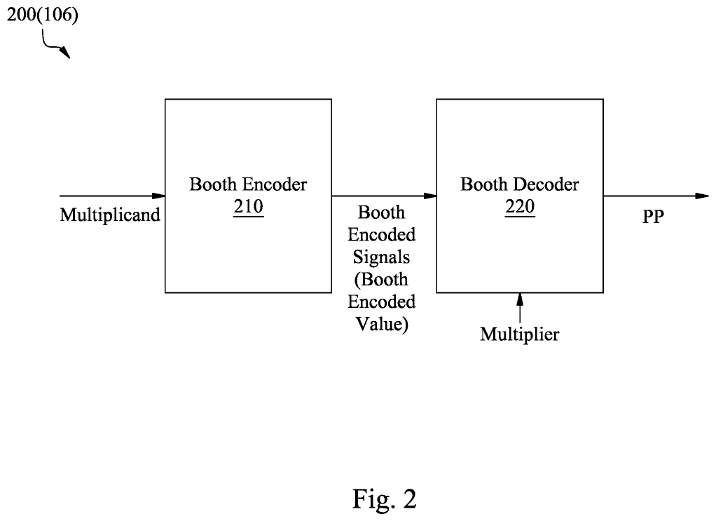

FIG. 2 illustrates a block diagram 200 of one of the computation blocks of the computation circuit 106 (hereinafter “computation block 200”), in accordance with various embodiments of the present disclosure. As described above, the computation block 200 (or the computation block of the computation circuit 106) can receive an input data element XIN and a weight data element W from the input circuit 104, generate a number of partial products based on the Booth algorithm, and provide the partial products to the adder tree 108 for generating a final product. It should be appreciated that the block diagram of the computation circuit 200 depicted in FIG. 2 has been simplified, and thus, the computation circuit 200 can include any of various other components (e.g., sign-aware multiplexers) while remaining within the scope of the present disclosure.

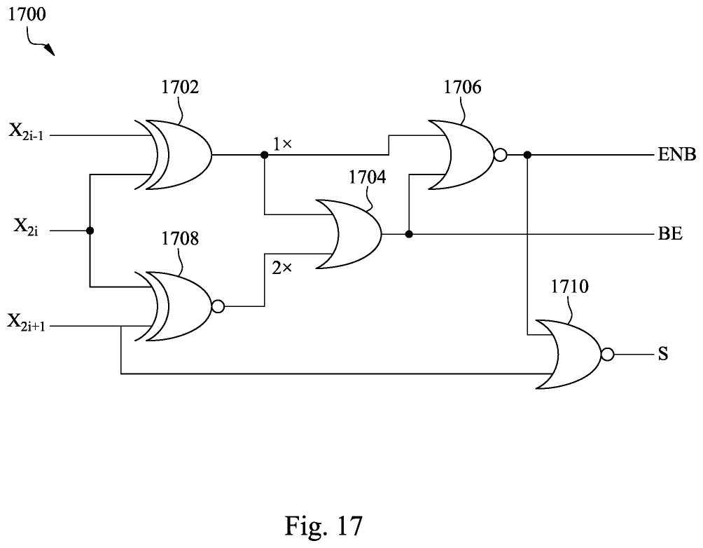

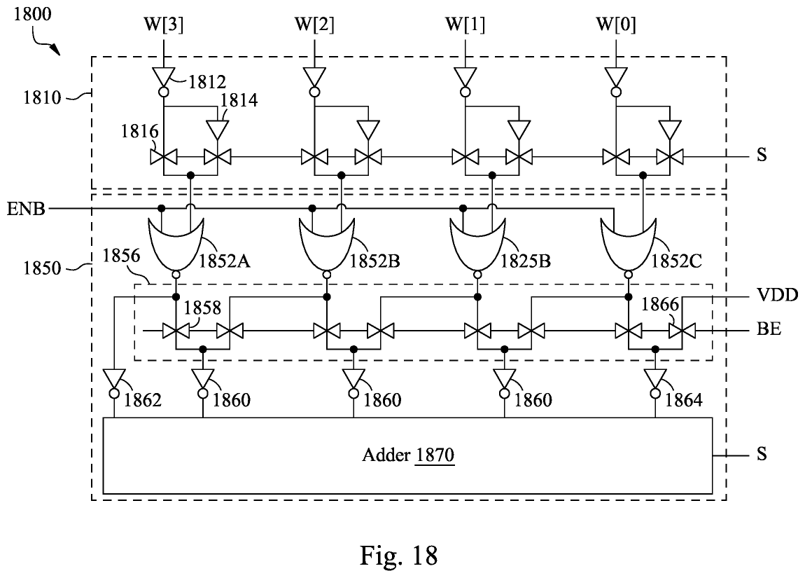

As shown, the computation circuit 200 includes a Booth encoder 210 and a Booth decoder 220. The Booth encoder 210 can receive a multiplicand (e.g., the input data element XIN and/or a subset of the input data element XIN). The Booth encoder 210 and the Booth decoder 220 may each be a circuit or combination of logic components (e.g., FIG. 17 and FIG. 18). The Booth encoder 210 can generate and output a plurality of Booth encoded signals (which, e.g., may include an enable bit, a Booth encoded bit, and a select bit) from the multiplicand. Different combinations of logic states of the Booth encoded signals may correspond to respective Booth encoded values. The Booth decoder 220 can receive a multiplier (e.g., the weight data element W and/or a subset of the weight data element W). The Booth decoder 220 can further receive, from the Booth encoder 210, the Booth encoded signals, and multiply the multiplier by the corresponding Booth encoded values to generate a partial product (PP). In one aspect of the present disclosure (e.g., FIG. 5), the Booth encoded value received by the Booth decoder 220 can be forwarded or selected by a number of sign-aware multiplexers coupled between the Booth encoder 210 and the Booth decoder 220. In another aspect of the present disclosure (e.g., FIG. 10), the Booth encoded value can be directly received by the Booth decoder 220, e.g., not through a sign-aware multiplexer.

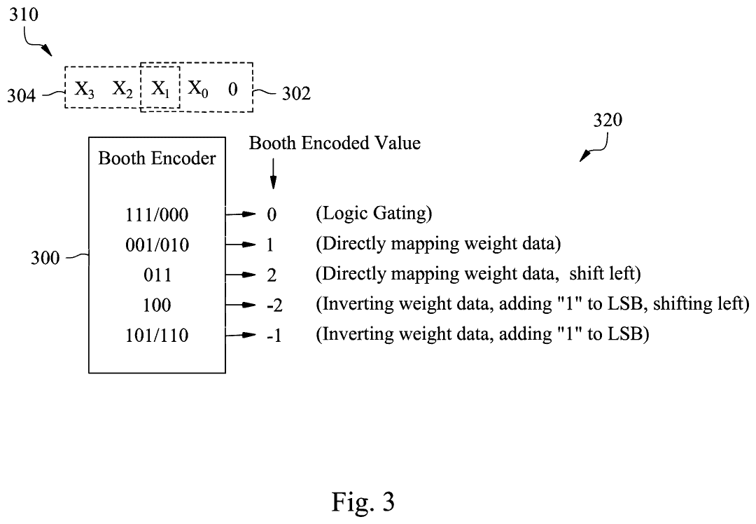

FIG. 3 illustrates an example of Booth encoding of an input data element for Booth multiplication in a CIM circuit (e.g., 100 of FIG. 1), in accordance with various embodiments of the present disclosure. As shown, a Booth encoder 300 (e.g., an implementation of the Booth encoder 210 of FIG. 2) can encode or otherwise convert a data element 310 into a number of Booth encoded signals 320 that correspond to one of a plurality of Booth encoded values (e.g., 0, −1, 1, −2, 2).

In some embodiments, the data element 310 may include one or more input data elements XIN, which serve as the multiplicand of a CIM circuit, while one or more corresponding weight data elements W may serve as the multiplier. In some other embodiments, the data element 310 may include one or more weight data elements W, which serve as the multiplicand of a CIM circuit, while one or more corresponding input data elements XIN may serve as the multiplier. The following discussion will be focused on the example of the input data elements XIN being encoded (i.e., the input data elements XIN serving as a multiplicand and the weight data elements W serving as a multiplier).

The Booth encoder 300 may encode the input data element XIN 310 in various cycles in which the Booth encoder 300 may encode subsets 302, 304 of the input data element XIN 310. Booth encoding the input data element XIN 310 may simplify the input data element XIN 310 by converting the input data element XIN 310 to the Booth encoded signals 320 associated with a limited number of operations for executing Booth multiplication in a CIM circuit. As described further herein, the Booth encoder 300 can convert each of the subsets 302 and 304 to a number of Booth encoded signals 320, which collectively correspond to a respective Booth encoded value. The Booth encoded signals 320 may be configured to control other parts of the corresponding CIM circuit (a Booth decoder such as, 220 of FIG. 2), causing the Booth decoder to multiply a weight data element W by the corresponding Boothe encoded value for generating a partial product.

In some embodiments, the subsets 302 and 304 of the input data element XIN 310 may overlap. In some embodiments, the subsets 302 and 304 may be centered around a bit location and include a bit location immediately before the bit location and a bit location immediately after the bit location. For the subset 302 centered around a least significant bit of the input data element XIN 310, a “0” bit may be added to the input data element XIN 310 to fill the bit location immediately before the least significant bit.

Illustrated in FIG. 3 is a non-limiting example of 3-bit Booth encoding, encoding 3-bit subsets 302, 304 of the input data element XIN 310. A multiplication operation for execution by a part of the CIM circuit (e.g., the Booth decoder 220 of FIG. 2) may be a multiplication of the input data element XIN and a weight data element W. The input data element XIN 310 may be of any bit length “p,” such that the input data element XIN 310 may include bits Xₚ₋₁, . . . , X₀.

In the illustrated example of FIG. 3, the input data element XIN 310 has 4 bits, i.e., p=4. The Booth encoder 300 may encode subsets 302, 304 of the input data element XIN 310 in various cycles, in which each of the subsets 302 and 304 has 3 bits. Each subset 302, 304 may be used to generate a respective number of Booth encoded signals 320. For example, the input data element XIN 310 may include bits X₃, X₂, X₁, X₀. A “0” bit may be added to the input data element XIN 310, for example, appended to the least significant bit X₀, so that the input data element XIN 310 may include bits X₃, X₂, X₁, X₀, 0. The “0” bit may be added to fill out the subset 302 centered around the least significant bit X₀. In this example, the subsets 302, 304 for 3-bit Booth encoding may each include bits centered at a bit location including a bit location immediately before the bit location and a bit location immediately after the bit location. Each successive subset 302, 304 may be centered at a bit location successive to the previous subset 302, 304. For example, the subsets 302, 304 may be expressed as bits X_{2i+1,} X₂ᵢ, and X₂ᵢ₋₁, where “i” may be the number of a cycle iteration. For a first cycle, e.g., i=0, there may not be an X₂ᵢ₋₁bit, as there may not be a less significant bit than the least significant bit X₀, and the “0” bit appended to the least significant bit X₀ may be used instead. As successive subsets 302, 304 are centered at a bit location successive to the previous subset 302, 304, a least significant bit of a successive subset 302, 304 may overlap with a most significant bit of a previous subset 302, 304. In other words, the X₂ᵢ₋₁ bit of the successive subset 302, 304 and the X₂ᵢ₊₁ bit of the previous subset 302, 304 may overlap in successive iterations (e.g., bit X₂ᵢ₋₁ where i=1 and bit X₂ᵢ₊₁ where i=0 are both X₁ bit). As such, the Booth encoder 300 can encode 2 bits of the input data element XIN 310 that have not been previously encoded (e.g., bits X₂ᵢ₊₁, X₂ᵢ) and 1 bit of the input data element XIN 310 that has been previously encoded (e.g., bit X₂ᵢ₊₁) in successive iterations.

For example, from a subset 302, 304 of bits “111” and/or “000”, the Booth encoder 300 may generate Booth encoded signals 320 that represent a “0” Booth encoded value for multiplication with a corresponding weight data element W, such as by indicating a logic gating operation to achieve the result of the multiplication. Logic gating may prevent bits of the weight data element W from propagating in the CIM circuit, resulting in a “low” or “0” signal in place of the weight data element W, effectively multiplying the weight data element W by a “0” value.

From a subset 302, 304 of bits “001” and/or “010”, the Booth encoder 300 may generate Booth encoded signals 320 that represent a “1” Booth encoded value for multiplication with a corresponding weight data element W, such as by indicating a direct mapping operation of the weight data element W in the CIM circuit to achieve the result of the multiplication. Direct mapping in the CIM circuit may enable bits of the weight data element W to propagate in the CIM circuit unchanged, resulting in signals representative of the unchanged weight data, effectively multiplying the weight data element W by a “1” value.

From a subset 302, 304 of bits “011”, the Booth encoder 300 may generate Booth encoded signals 320 that represent a “2” Booth encoded value for multiplication with a corresponding weight data element W, such as by indicating a direct mapping operation of the weight data element W and a left shift operation (e.g., left shift by 1 bit in an adder) on the weight data element W in the CIM circuit to achieve the result of the multiplication. Left shifting direct mapped weight data element W in the CIM circuit may shift bits of the weight data element W by an amount that changes the bits of the weight data element W, resulting in signals representative of the weight data element W multiplied by a “2” value.

From a subset 302, 304 of bits “100”, the Booth encoder 300 may generate Booth encoded signal 320 that represent a “−2” Booth encoded value for multiplication with a corresponding weight data element W, such as by indicating an inversion operation of the weight data element W, an addition operation of a “1” value at a least significant bit of the inverted weight data element, and left shift operation (e.g., left shift by 1 bit in an adder) on the sum in the CIM circuit to achieve the result of the multiplication. Inverting bits of the weight data element W and addition of a “1” value at a least significant bit of the inverted bits of the weight data element W in the CIM circuit may generate signals representative of a negative signed version of the weight data element W, effectively multiplying the weight data element W by a “−1” value. Left shifting the negative signed version of the weight data element W in the CIM circuit may shift bits of the negative signed version of the weight data element W by an amount that changes the bits of the negative signed version of the weight data element W, resulting in signals representative of the negative signed version of the weight data element W multiplied by a “2” value. Together, these operations may result in signals representative of the weight data element W multiplied by a “−2” value.

From a subset 302, 304 of bits “101” and/or “110”, the Booth encoder 300 may generate Booth encoded signals 320 that represent a “−1” Booth encoded value for multiplication with a corresponding weight data element W, such as by indicating an inversion operation of the weight data element W and an addition operation of a “1” value at a least significant bit of the inverted weight data element W in the CIM circuit to achieve the result of the multiplication. Inverting bits of the weight data element W and addition of a “1” value at a least significant bit of the inverted bits of the weight data element W in the CIM circuit may generate signals representative of a negative signed version of the weight data element W, effectively multiplying the weight data element W by a “−1” value.

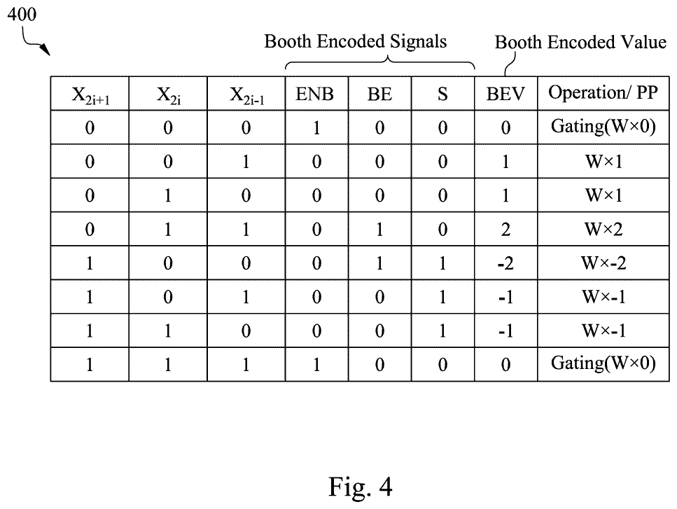

FIG. 4 illustrates a non-limiting example of a table 400 of the Booth encoder 300 encoding one of the subsets 302 and 304 of the input data element XIN 310 (e.g., X₂ᵢ₊₁, X₂ᵢ, and X₂ᵢ₋₁) to generate the Booth encoded signals 320, in accordance with various embodiments of the present disclosure. As a non-limiting example, the Booth encoded signals 320 include an enable bit (“ENB”), a Booth encoded bit (“BE”), and a select bit (“S”). Different combinations of logic states of these bits, ENB, BE, and S, may correspond to respective Booth encoded values. Further, the bits, ENB, BE, and S, can be provided to a Booth decoder, that function as control bits for the Booth decoder. Upon receiving the control bits, the Booth decoder can multiply a received weight data element W by the Booth encoded value.

As a representative example, the Booth encoder 300 receiving the subset 302, 304 of bits “000” and/or “111” may generate and output the Booth encoded signals 320 (e.g., ENB, BE, S) of bits “100,” which may be configured to cause a corresponding Booth decoder to multiply the weight data element W by a “0” value. The Booth decoder may be configured to interpret/be controlled by the Booth encoded signal 320 of bits “100” to perform logic gating on the weight data element W. As another representative example, the Booth encoder 300 receiving the subset 302, 304 of bits “001” and/or “110” may generate and output the Booth encoded signals 320 (e.g., ENB, BE, S) of bits “000,” which may be configured to cause a corresponding Booth decoder to multiply the weight data element W by a “1” value. The Booth decoder may be configured to interpret/be controlled by the Booth encoded signal 320 of bits “000” to perform direct mapping on the weight data element W. Other combinations of the logic states of the ENB, BE, and S, together with respective Booth encoded values (or operations performed by the corresponding Booth decoder), are summarized in the table 400.

FIG. 5 illustrates a schematic diagram of an example implementation of the computation block 200 of FIG. 2 (hereinafter “computation block 500”), in accordance with various embodiments of the present disclosure. The computation block 500 can be configured to process (e.g., encode) one of plural subsets of an input data element XIN and multiply a weight data element W by the encoded input data element XIN. Generally, the input data element XIN and the weight data element W may be provided as signed data elements. It should be understood that the schematic diagram of FIG. 5 has been simplified, and thus, the computation block 500 can include any of various other components while remaining within the scope of the present disclosure.

As shown, the computation block 500 includes a Booth encoder 510 (e.g., 210 of FIG. 2) and a Booth decoder 520 (e.g., 220 of FIG. 2), and a number of sign-aware multiplexers 530, 540, 550, and 560. The sign-aware multiplexers 530, 540, 550, and 560 are operatively coupled between the Booth encoder 510 and the Booth decoder 520, in various embodiments. In the example where the Booth encoder 510 is implemented as a 3-bit Booth encoder (sometimes referred to as a radix-4 Booth encoder), such as the encoder 300 shown in FIG. 3, the number of sign-aware multiplexers may be equal to 4. These 4 sign-aware multiplexers may correspond to the Booth encoded values provided by the Booth encoder 510, 1, −1, −2, and 2, respectively. In other words, the Booth encoder 510 may operatively (e.g., not physically) have four symbolic or operative outputs that correspond to (or otherwise provide) the Booth encoded values, 1, −1, −2, and 2, respectively. Further, the Booth encoder 510 can be implemented as any of various other Booth encoders (e.g., a radix-2 Booth encoder, a radix-8 Booth encoder), which may change a number of the corresponding sign-aware multiplexers, while remaining within the scope of the present disclosure.

The Booth encoder 510 is configured to encode one of the subsets of a received input data element XIN based on the Booth algorithm, and provide Booth encoded signals during each cycle. The Booth decoder 520 is configured to receive a weight data element W (or one of plural subsets of the weight data element W), and multiply the weight data element W by a Booth encoded value determined based on the Booth encoded signals (provided by the Booth encoder 510) so as to provide a number of partial products. In various embodiments, the sign-aware multiplexers 530 to 560 are operatively coupled between the Booth encoder 510 and the Booth decoder 520.

The input data element XIN and the weight data element W, processed by the computation block 500, can be in an integer data type or a floating point data type, each of which may have a sign bit. That is, each of the input data element XIN and the weight data element W is provided as a signed data element. As such, the sign-aware multiplexers 530 to 560 can receive the Booth encoded signals and operatively adjust the Booth encoded signals based on a logically processed signal of the sign bit of the input data element XIN (sometimes referred to as “XINsign”) and the sign bit of the weight data element W (sometimes referred to as “Wsign”). However, in some other embodiments, the computation block 500 can multiply an unsigned input data element by an unsigned weight data element, while remaining within the scope of the present disclosure. For example, when unsinged data elements are provided, the computation block 500 can deactivate the sign-aware multiplexers 530 to 560; and when singed data elements are provided, the computation block 500 can activate the sign-aware multiplexers 530 to 560.

Each of the sign-aware multiplexers 530 to 560 has a first input, a second input, and an output. The first input of the sign-aware multiplexer can receive a first combination of respective logic states of the Booth encoded signals, and the second input of the sign-aware multiplexer can receive a second combination of the respective logic states of the Booth encoded signals. Equivalently, the first combination of the logic states of the Booth encoded signals can correspond to a first Booth encoded value, and the second combination of the logic states of the Booth encoded signals can correspond to a second Booth encoded value. In various embodiments, the first Booth encoded value and the second Booth encoded value, equivalently received by the first and second inputs of each of the sign-aware multiplexers 530 to 560, have opposite polarities but an identical magnitude. For example, in FIG. 5, the sign-aware multiplexer 530 can receive the Booth encoded values, 1 and −1, at its first input and second input respectively; the sign-aware multiplexer 540 can receive the Booth encoded values, −1 and 1, at its first input and second input respectively; the sign-aware multiplexer 550 can receive the Booth encoded values, −2 and 2, at its first input and second input respectively; and the sign-aware multiplexer 560 can receive the Booth encoded values, 2 and −2, at its first input and second input respectively.

In some embodiments, each of the sign-aware multiplexers 530 to 560 can be controlled by an XOR'ed signal of XINsign and Wsign, sometimes referred to as “XOR(Wsign,XINsign).” When XINsign and Wsign are provided as “00” or “11,” the XOR'ed signal is equal to logic “0;” and when XINsign and Wsign are provided as “01” or “10,” the XOR'ed signal is equal to logic “1.” That is, when the signs of the input data elements XIN and the weight data elements W are identical to each other, the XOR'ed signal is equal to logic “0;” and when the signs of the input data elements XIN and the weight data elements W are different from each other, the XOR'ed signal is equal to logic “1.”

Based on the signal XOR(Wsign,XINsign) being equal to logic “0,” the sign-aware multiplexers 530 to 560 can each select the signals (or equivalent Booth encoded value) received at its first input; and while the signal XOR(Wsign,XINsign) being equal to logic “1,” the sign-aware multiplexers 530 to 560 can each select the signals (or equivalent Booth encoded value) received at its second input. Stated another way, the sign-aware multiplexers 530 to 560 can each select the first Booth encoded value, when the input data element XIN and weight data element W have the same sign; and select the second Booth encoded value, when the input data element XIN and weight data element W have different signs. Equivalently, the sign-aware multiplexers 530 to 560 can determine whether to adjust the Booth encoded signals based on whether the signs of the input data element XIN and weight data element W are the same (a positive product) or different (a negative product).

As a representative example, when the signal XOR(Wsign,XINsign) is “0” and the Booth encoded signals provided by the Booth encoder 510 correspond to the Booth encoded value “1,” the sign-aware multiplexer 530 can select the Booth encoded value “1” and provide it to the Booth decoder 520. That is, the sign-aware multiplexer 530 may directly forward the Booth encoded value provided by the Booth encoder 510 to the Booth decoder 520, when the signal XOR(Wsign,XINsign) is “0.” As another representative example, when the signal XOR(Wsign,XINsign) is “1” and the Booth encoded signals provided by the Booth encoder 510 correspond to the Booth encoded value “1,” the sign-aware multiplexer 530 can select the Booth encoded value “−1” and provide it to the Booth decoder 520. Equivalently, upon identifying the signal XOR (Wsign,XINsign) is equal to “1,” the sign-aware multiplexers 530 to 560 can “adjust” the Booth encoded value provided by the Booth encoder 510 by selecting a Booth encoded value with an opposite polarity, and provide the adjusted Booth encoded value to the Booth decoder 520.

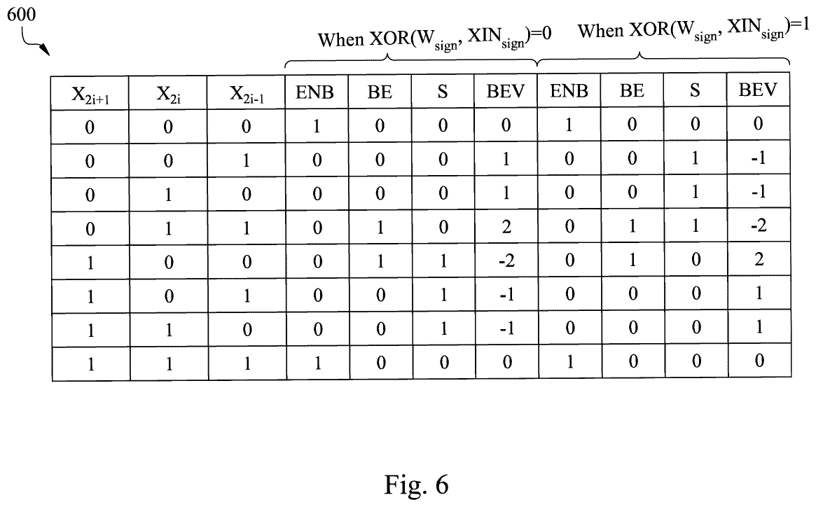

FIG. 6 illustrates a non-limiting example of a table 600 summarizing the computation block 500 (FIG. 5) encoding the subset of an input data element XIN (e.g., X₂ᵢ₊₁, X₂ᵢ, and X₂ᵢ₋₁), generating a Booth encoded value (or Booth encoded signals), selectively adjusting the generated Booth encoded value based on signs of the input data element XIN and a weight data element W, and multiplying the weight data element W by the selectively adjusted Booth encoded value, in accordance with various embodiments of the present disclosure.

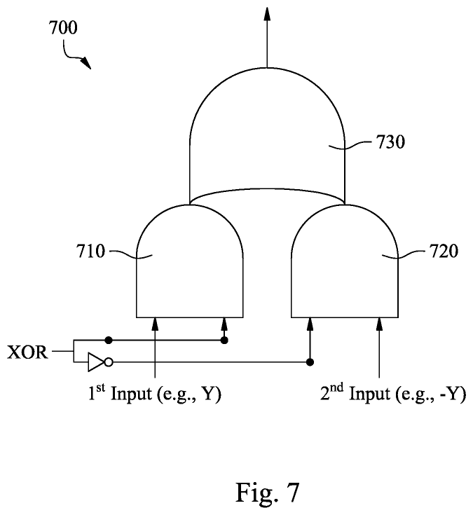

FIG. 7 illustrates an example circuit diagram of each of the sign-aware multiplexers 530 to 560 (hereinafter “multiplexer 700”), in accordance with various embodiments of the present disclosure. In the example of FIG. 7, the multiplexer 700 is implemented as a two-input-one-output multiplexer (sometimes referred to as 2-to-1 MUX or 2:1 MUX) with AND-OR-INVERT (AOI) logic gates. That is, the multiplexer 700 is configured to select one of two input signals based on a control signal. It should be understood that the multiplexer 700 can be implemented as any of various other configurations (e.g., with OR-AND-INVERT (OAI) logic gates), while remaining within the scope of the present disclosure.

As shown, the multiplexer 700 includes a first AND logic gate 710, a second AND logic gate 720, and an OR logic gate 730. The multiplexer 700 may have: (i) a first input, connected to one of the inputs of the AND logic gate 710, with the other input of the AND logic gate 710 configured to directly receive the signal XOR (Wsign,XINsign); and (ii) a second input, connected to one of the inputs of the AND logic gate 720, with the other input of the AND logic gate 720 configured to receive the signal XOR(Wsign,XINsign) through an inverter. The AND logic gate 710 and the AND logic gate 720 can have their outputs connected to the OR logic gate 730. In the example where the sign-aware multiplexer 530 is implemented as the multiplexer 700, the first input and the second input of the multiplexer 700 are configured to receive a first Booth encoded value “1” and a second Booth encoded value “−1.” As such, when the signal XOR(Wsign,XINsign) is equal to “0,” the multiplexer 700 (or 530) selects a first combination of the logic states of Booth encoded signals that correspond to the Booth encoded value “1;” and when the signal XOR (Wsign,XINsign) is equal to “1,” the multiplexer 700 (or 530) selects a second combination of the logic states of Booth encoded signals that correspond to the Booth encoded value “−1.”

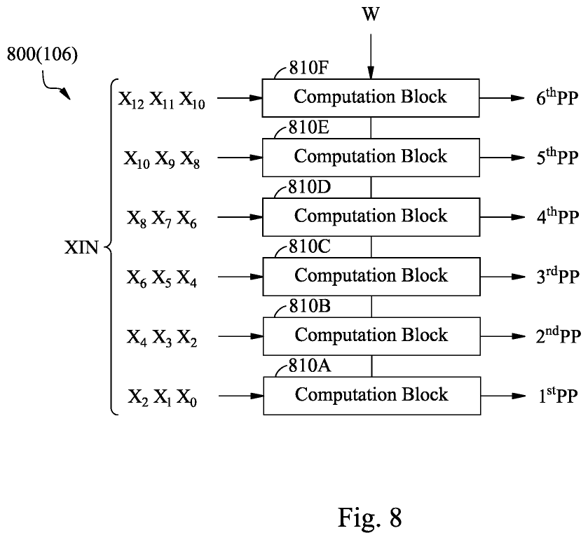

FIG. 8 illustrates an example block diagram 800 of the computation circuit 106 (hereinafter “computation circuit 800”), in accordance with various embodiments of the present disclosure, in accordance with various embodiments of the present disclosure. In the illustrative example of FIG. 8, the computation circuit 800 can be configured to process (e.g., encode) an input data element XIN with 12 bits (X₁₂, X₁₁, X₁₀, X₉, X⁸, X₇, X₆, X₅, X₄, X₃, X₂, X₁) and multiply a weight data element W by the encoded input data element XIN to generate a number of partial products.

As shown, the computation circuit 800 can have 6 computation blocks 810A, 810B, 810C, 810D, 810E, and 810F. Each of the computation blocks 810A to 810F can be configured as the computation block 500 of FIG. 5, such as to encode a 3-bit subset of the input data element XIN for generating a Booth encoded value and to multiply the weight data element W by the corresponding selected Booth encoded value for generating a partial product. However, it should be understood that the computation circuit 800 can process data elements with any number of bits. Therefore, the number of computation blocks, included in the computation circuit 800, may change accordingly. For example, for processing data elements with 8 bits, the computation circuit 800 may have 4 computation blocks, each of which is configured to generate a partial product. In general, the number (N₁)of computation blocks of the computation circuit 800 is equal to one half of the number (N₂) of data element bits received by the computation circuit 800.

For example, the computation block 810A can encode the subset of (X₂, X₁, 0) to generate a first Booth encoded value (e.g., 0, 1, −1, −2, or 2) and multiply the weight data element W by the first Booth encoded value for generating a first partial product; the computation block 810B can encode the subset of (X₄, X₃, and X₂) to generate a second Booth encoded value (e.g., 0, 1, −1, −2, or 22) and multiply the weight data element W by the second Booth encoded value for generating a second partial product; the computation block 810C can encode the subset of (X₆, X₅, and X₄) to generate a third Booth encoded value (e.g., 0, 1, −1, −2, or 2) and multiply the weight data element W by the third Booth encoded value for generating a third partial product; the computation block 810D can encode the subset of (X₈, X₇, and X₆) to generate a fourth Booth encoded value (e.g., 0, 1, −1, −2, or 2) and multiply the weight data element W by the fourth Booth encoded value for generating a fourth partial product; the computation block 810E can encode the subset of (X₁₀, X₉, and X₈) to generate a fifth Booth encoded value (e.g., 0, 1, −1, −2, or 2) and multiply the weight data element W by the fifth Booth encoded value for generating a fifth partial product; the computation block 810F can encode the subset of (X₁₂, X₁₁, and X₁₀) to generate a sixth Booth encoded value (e.g., 0, 1, −1, −2, or 2) and multiply the weight data element W by the sixth Booth encoded value for generating a sixth partial product. These 6 partial products can then be summed up (by an adder tree such as, 108 of FIG. 1) to induce a final product of the input data element XIN and weight data element W.

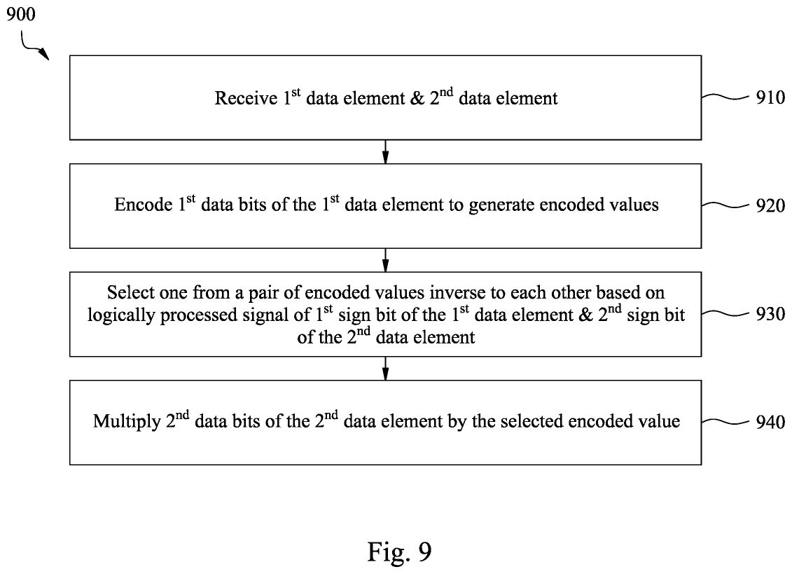

FIG. 9 illustrates a flow chart of an example method 900 for performing MAC operations on an input data element XIN and a weight data element W, in accordance with various embodiments of the present disclosure. In some embodiments, the input data element XIN and the weight data element W may each be provided as a signed data element. The operations of the method 900 may be performed by the components described above in, e.g., FIG. 5, and thus, some of the reference numerals used above may be re-used the following discussion of the method 900. Further, it is understood that the method 900 has been simplified, and thus, additional operations may be provided before, during, and after the method 900 of FIG. 9, and that some other operations may only be briefly described herein.

The method 900 starts with operation 910 of receiving a first data element and a second data element. The first data element may be an input data element XIN, and the second data element may be a weight data element W. In some embodiments, each of the input data element XIN and weight data element W may be received as a signed data element, which can be in an integer data type of floating point data type. As such, the input data element XIN has a first sign bit and a number of first data bits, and the weight data element W has a second sign bit and a number of second data bits. Using the computation block 500 of FIG. 5 as a non-limiting example, the Booth encoder 510 can receive the input data element XIN, and the Booth decoder 520 can receive the weight data element W.

The method 900 continues to operation 920 of encoding the first data bits of the first data element to generate a number of encoded values. Continuing with the above example, the Booth encoder 510, which is implemented as a 3-bit Booth encoder, can encode a 3-bit subset of the first data bits during each cycle. In the example where a number of the first data bits is equal to 4 (e.g., X₃, X₂, X₁, X₀), the Booth encoder 510 can generate a first combination of logic states of Booth encoded signals that correspond to a first Booth encoded value (e.g., “1”) during a first cycle, and generate a second combination of logic states of Booth encoded signals that correspond to a second Booth encoded value (e.g., “-1”) during a second cycle.

The method 900 continues to operation 930 of selecting one from a pair of Booth encoded values that are inverse to each other based on a logically processed signal of the first sign bit of the first data element and the second sign bit of the second data element. The pair of Booth encoded values, inverse to each other, have opposite polarities but the same magnitude. Continuing with the above example, after the Booth encoder 510 generates the first Booth encoded value “1” and provides it to the corresponding sign-aware multiplexer (e.g., 530), the multiplexer 530 can determine whether to directly forward the first Booth encoded value “1” to the Booth decoder 520 or selecting another Booth encoded value inverse to “1,” i.e., “-1,” based on an XOR'ed signal on the first sign bit and the second sign bit. If the XOR'ed signal is equal to “0,” which represents that the input data element XIN and the weight data element W have the same sign, the multiplexer 530 can directly forward (select) the first Booth encoded value “1” to the Booth decoder 520; and if the XOR'ed signal is equal to “1,” which represents that the input data element XIN and the weight data element W have different signs, the multiplexer 530 can inverse the first Booth encoded value to “−1” and provide (select) it to the Booth decoder 520.

The method 900 continues to operation 940 of multiplying the second data bits of the second data element by the selected encoded value. Upon receiving the selected Booth encoded value, the Booth decoder 520 can multiply the weight data element W by the selected Booth encoded value for generating a partial product. Using the same example above, if the XOR'ed signal is equal to “0,” during the first cycle (where the first Booth encoded value is provided as “1”), the Booth decoder 520 then multiply the weight data element W by 1; and if the XOR'ed signal is equal to “1,” during the first cycle (where the first Booth encoded value is provided as “1”), the Booth decoder 520 then multiply the weight data element W by −1. After the partial product is generated during each cycle, all the partial products can be summed up to generate a final product. In the above example where the input data element XIN has 4 bits, two partial products can be summed up to generate a final product of the input data element XIN and the weight data element W.

FIG. 10 illustrates a schematic diagram of an example implementation of the computation circuit 106 of FIG. 1, or a plural number of computation blocks 200 of FIG. 2, (hereinafter “computation circuit 1000”), in accordance with various embodiments of the present disclosure. The computation circuit 1000 can be configured to process (e.g., encode) an input data element XIN and multiply a weight data element W by the encoded input data element XIN. In various embodiments, the input data element XIN and the weight data element W may be provided as either signed or unsigned data elements. Accordingly, the computation circuit 1000 may have control pins to respectively indicate two signals (e.g., two bits), one of which (XSIGNED) is indicative of whether the input data element XIN is signed or unsigned and the other of which (WSIGNED) is indicative of whether the weight data element W is signed or unsigned. It should be understood that the schematic diagram of FIG. 10 has been simplified, and thus, the computation circuit 1000 can include any of various other components while remaining within the scope of the present disclosure.

As shown, the computation circuit 1000 includes a number of Booth encoders 1010A to 1010F (e.g., each of which can correspond to 210 of FIG. 2) and a number of Booth decoders 1020A to 1020F (e.g., each of which can correspond to 220 of FIG. 2), and a number of logic components 1030, 1040, and 1050. In the illustrative example of FIG. 10, the data elements (e.g., XIN and W) received by the computation circuit 1000 each have 12 bits (e.g., XIN[11:0] and W[11:0]). In such an example, the computation circuit 1000 can include 6 Booth encoders, 1010A to 1010F, and 6 corresponding Booth decoders, 1020A to 1020F. It should be understood that the data element processed by the computation circuit 1000 can have any other number of bits, while remaining within the scope of the present disclosure. The computation circuit 1000 can be operatively coupled to an adder tree 1060 (an example implementation of the adder tree 108 of FIG. 1), which can include a number of full adders, 1061, 1062, 1063, 1064, 1065, and 1066.

The Booth encoders, 1010A to 1010F, can each be implemented as a 3-bit Booth encoder (e.g., the encoder 300 shown in FIG. 3), and each of the Booth encoders, 1010A to 1010F, can be operatively coupled to a corresponding one of the Booth decoders, 1020A to 1020F. In the example where the input data element XIN has 12 bits (e.g., signal 1001, which can be presented as XIN[11:0]), each of the Booth encoders can encode one of plural subsets of signal 1001 (XIN[11:0]) and provide a Booth encoded value to the corresponding Booth decoder.

For example, the Booth encoder 1010A can encode a first subset of signal 1001 (XIN[11:0]) for generating a first Booth encoded value and provide the first Booth encoded value to the Booth decoder 1020A; the Booth encoder 1010B can encode a second subset of signal 1001 (XIN[11:0]) for generating a second Booth encoded value and provide the second Booth encoded value to the Booth decoder 1020B; the Booth encoder 1010C can encode a third subset of signal 1001 (XIN[11:0]) for generating a third Booth encoded value and provide the third Booth encoded value to the Booth decoder 1020C; the Booth encoder 1010D can encode a fourth subset of signal 1001 (XIN[11:0]) for generating a fourth Booth encoded value and provide the fourth Booth encoded value to the Booth decoder 1020D; the Booth encoder 1010E can encode a fifth subset of signal 1001 (XIN[11:0])for generating a fifth Booth encoded value and provide the fifth Booth encoded value to the Booth decoder 1020E; and the Booth encoder 1010F can encode a sixth subset of signal 1001 (XIN[11:0]) for generating a sixth Booth encoded value and provide the sixth Booth encoded value to the Booth decoder 1020F.

In various embodiments of the present disclosure, the computation circuit 1000 can use the logic components 1030, 1040, and 1050 to process the input data element XIN and weight data element W, regardless of whether the input data element XIN and weight data element W are each provided as unsigned or signed. For example, the logic component 1030 may be a NAND2 gate, the logic component 1040 may be a NOR2 gate, and the logic component 1050 may be a half adder. The logic component 1030 can NAND signals 1003 and 1005 to provide signal 1017; the logic component 1040 can NOR signals 1011 and 1017 to provide signal 1019; and the logic component 1050 can add one bit to signal 1013 to provide signal 1015. Each of these logic components and signals will be described in detail as follows.

Signal 1003, received at one of the inputs of the logic component 1030, can represent

a most significant bit of signal 1001, e.g., XIN[11]. Signal 1005, received at the other input of the logic component 1030, can represent a logically inversed version of the signal indicated at one of the control pins, e.g., XSIGNEDB. In some embodiments, the logic component 1030 can provide NAND(XIN[11],XSIGNEDB) as signal 1017.

Signal 1011, received at one of the inputs of the logic component 1040, can represent a logically inversed version of the weight data element, WB[11:0]. In some embodiments, upon receiving signal 1017 from the logic component 1030 at its other input, the logic component 1040 can provide NOR(NAND(XIN[11],XSIGNEDB), WB[11:0]) as signal 1019, where NAND(XIN[11],XSIGNEDB) represents signal 1017. Signal 1019 can represent a partial product of one of the subsets of signal 1001 (XIN[11:0]), which includes its most significant bit and one or more bits appended to the left-hand side of the most significant bit.

Signal 1013, received by the logic component 1050, can represent the weight data element with an opposite polarity, −W. To generate signal 1015 (e.g., −W), the logic component 1050 can receive signal 1013 that is presented as NAND(WSIGNED,W[11]), WB[1:0] and add signal 1013 with a single-bit binary integer (not shown), in various embodiments. Specifically, signal 1013 (NAND(WSIGNED,W[11]), WB[11:0]) can represent performing sign extension on WB[11:0]. For example, when the weight data element W is provided as signed (i.e., WSIGNED=1), signal 1013 becomes NAND(1,W[11]),WB[11:0], which in turn becomes WB[11],WB[11:0]. WB[11], WB[11:0], as disclosed herein, refers to appending the most significant bit of WB[11:0] to its left-hand side. In another example, when the weight data element W is provided as unsigned (i.e., WSIGNED=0), signal 1013 becomes NAND(0,W[11]), W[11:0], which in turn becomes 1,WB[11:0], WB[11:0], as disclosed herein, refers to appending “1” to the left-hand side of WB[11:0]. As such, signal 1015 (−W) can be presented as WN[12:0].

Each of the Booth decoders 1020A to 1020F can receive two signals 1007 and 1009, which represent W and −W with sign extension, respectively. In various embodiments, signal 1007 can be presented as NOR(WSIGNEDB,WB[11]), W[11:0], and signal 1009 can be presented as WN[12],WN[12:0]. The Booth decoders 1020A to 1020F can each generate a partial product through multiplying the weight data element W by a corresponding Booth encoded value (e.g., provided by the corresponding one of the Booth encoders 1010A to 1010F). Specifically, each of the Booth decoders 1020A to 1020F can selectively adjust the received W and −W based on the corresponding Booth encoded value. Using the Booth decoder 1020F as a representative example, when receiving a Booth encoded value “2” from the Booth encoder 1010F, the Booth decoder 1020F can perform a left shift operation on the W. Using the Booth decoder 1020A as another representative example, when receiving a Booth encoded value “−2” from the Booth encoder 1010F, the Booth decoder 1020F can perform a left shift operation on the −W.

With such a configuration, based on whether signal 1001 (XIN[11:0]) is provided as signed or unsigned, the logic components 1030 and 1040 can collectively determine how to

process a partial product of the most significant bit of signal 1001 (e.g., XIN[11] or signal 1003). In general, when signal 1001 (XIN[11:0]) is provided as unsigned, the logic component 1040 can output signal 1019, based on a logically inversed version of the most significant bit of signal 1001 (e.g., XINB[11]), as either having its all bits equal to “0” or equal to the weight data element (W[11:0]). Equivalently, when the input data element XIN is provided as unsigned, a partial product corresponding to the most significant bit of the input data element (signal 1001 or XIN[11:0]) and the weight data element W, is either “0” or “W.” When signal 1001 (XIN[11:0]) is provided as signed, the logic component 1040 can output signal 1019 as having all “0,”

regardless of whether the most significant bit of signal 1001 (e.g., XINB[11]) is “1” or “0.” Equivalently, when the input data element XIN is provided as signed, a partial product corresponding to the most significant bit of the input data element (signal 1001 or XIN[11:0]) and the weight data element W, is always “0.” Advantageously, even with the capability of processing the data elements, either signed or unsigned, calculation loading of the computation circuit 1000 (and corresponding circuit design) has not been increased accordingly.

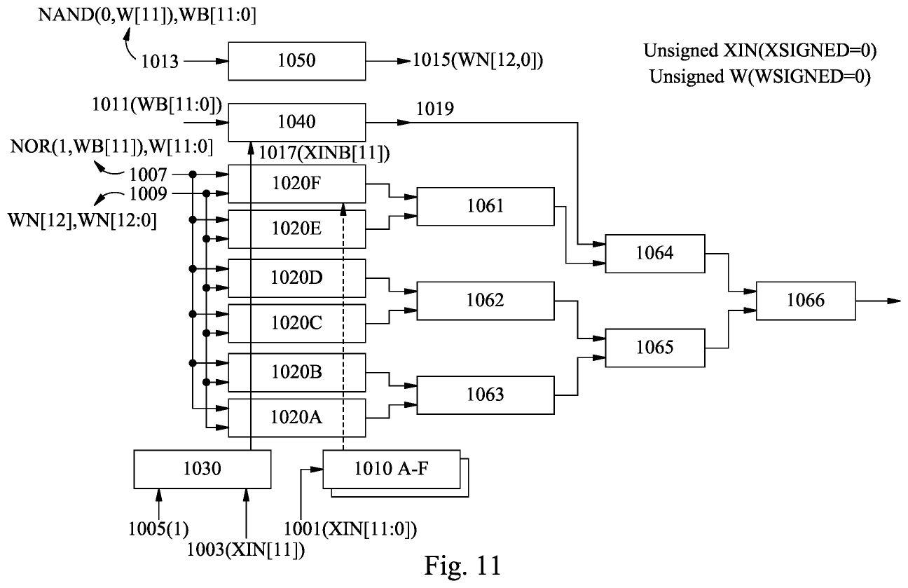

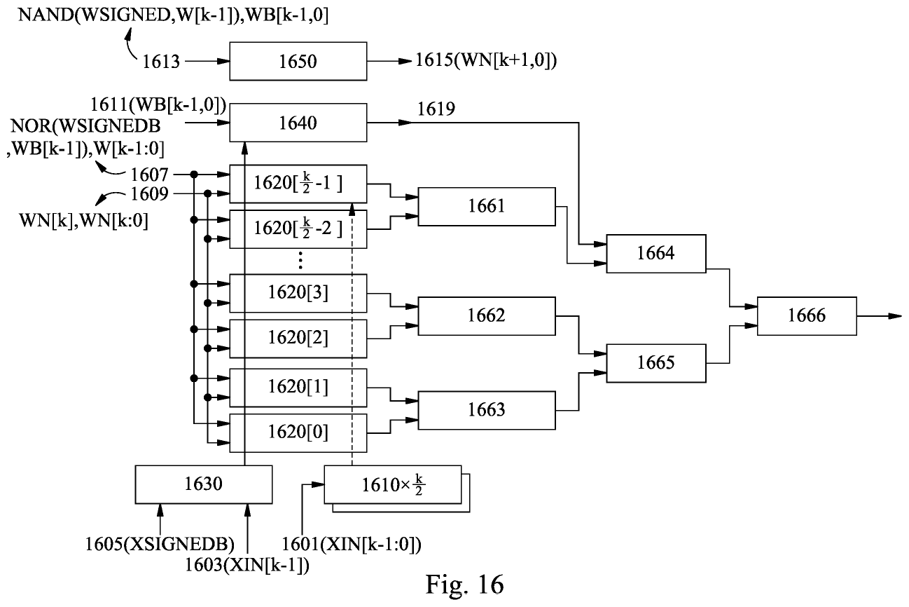

FIGS. 11, 12, 13, and 14 illustrate examples of the computation circuit 1000 processing four different combinations of signed or unsinged input data element XIN and signed or unsinged weight data element W, respectively. In the examples of FIGS. 11 to 14, each of the input data element XIN and weight data element W is provided with 12 bits. However, it should be understood that the number of bits of each of the input data element XIN and weight data element W processed by the computation circuit 1000 can vary (e.g., FIG. 16), while remaining within the scope of the present disclosure.

In FIG. 11, an example where the input data element XIN is provided as unsigned and the weight data element W is provided as unsigned (i.e., XSIGNED=0 and WSIGNED=0) is illustrated. As such, signal 1005, XSIGNEDB=1, which causes the logic component 1030 to output signal 1017 as XINB[11], by NAND'ing 1 and XIN[11]. In response, the logic component 1040 outputs signal 1019 as having its all bits equal to “0” or W[11:0], by NOR'ing XINB[11] and WB[11:0]. For example, when XINB[11]=1, signal 1019 is output as 12 bits of “0,” which refers to the partial product of the subset including the most significant bit of the input data

element XIN[11] and the weight data element W being equal to 0. When XINB[11]=0, signal 1019 is output as [11:0], which refers to the partial product of the subset including the most

significant bit of the input data element XIN[11] and the weight data element W being equal to W. In the current example, it is noted that each of the Booth decoders 1020A to 1020F receives signal 1007 (W) and signal 1009 (−W). Signals 1007 and 1009 can be presented as NOR(1, WB[11]), W[11:0] and WN[12],WN[12:0], respectively, where NOR(1,WB[11]), W[11:0] represents appending “0” bit(s) to the left-hand side of the most significant bit of the weight data element, W[11:0].

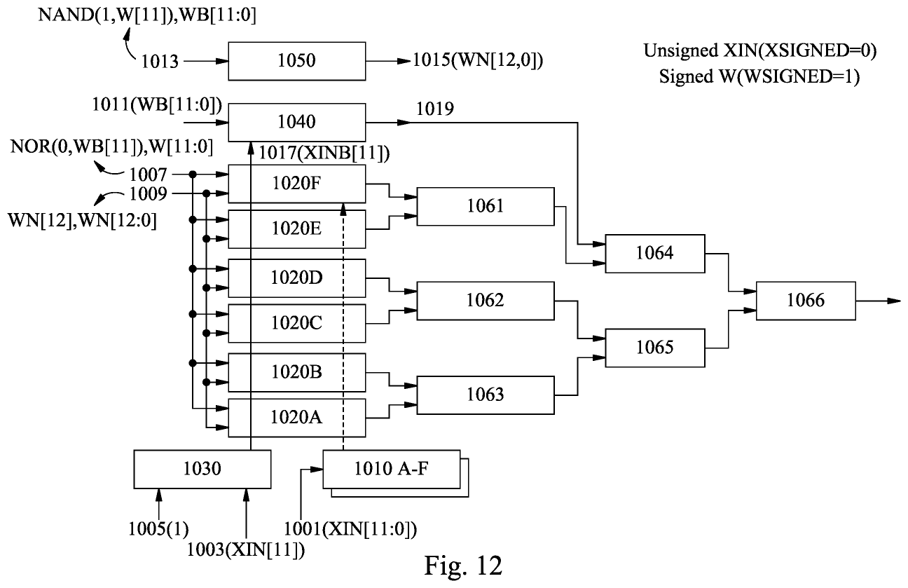

In FIG. 12, an example where the input data element XIN is provided as unsigned and the weight data element W is provided as signed (i.e., XSIGNED=0 and WSIGNED=1) is illustrated. As such, signal 1005, XSIGNEDB=1, which causes the logic component 1030 to output signal 1017 as XINB[11], by NAND'ing 1 and XIN[11]. In response, the logic component 1040 outputs signal 1019 as having its all bits equal to “0” or W[11:0], by NOR'ing XINB[11] and WB[11:0]. For example, when XINB[11]=1, signal 1019 is output as 12 bits of “0,” which refers to the partial product of the subset including the most significant bit of the input data

element XIN[11] and the weight data element W being equal to 0. When XINB[11]=0, signal 1019 is output as W[11:0], which refers to the partial product of the subset including the most

significant bit of the input data element XIN[11] and the weight data element W being equal to W. In the current example, it is noted that each of the Booth decoders 1020A to 1020F receives signal 1007 (W) and signal 1009 (—W). Signals 1007 and 1009 can be presented as NOR(0,WB[11]),W[11:0] and WN[12], WN[12:0], respectively, where NOR(1,WB[11]),W[11:0] represents appending additional most significant bit(s) to the left-hand side of the most significant bit of the weight data element, W[11:0].

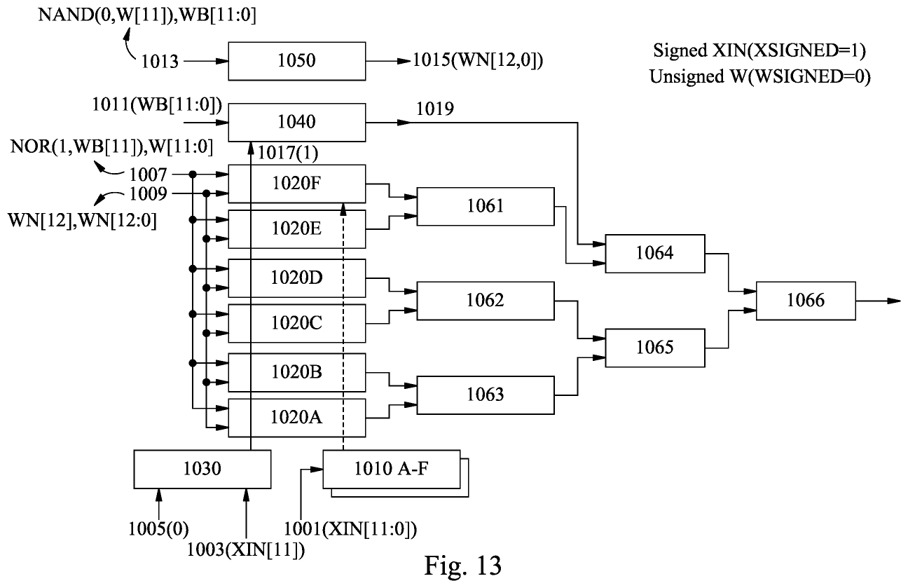

In FIG. 13, an example where the input data element XIN is provided as signed and the weight data element W is provided as unsigned (i.e., XSIGNED=1 and WSIGNED=0) is illustrated. As such, signal 1005, XSIGNEDB=0, which causes the logic component 1030 to

output signal 1017 as logic 1, by NAND'ing 0 and XIN[11]. In response, the logic component 1040 outputs signal 1019 as having all “0,” by NOR'ing “1” and WB[11:0], regardless of XINB[11] being equal to logic 1 or 0. For example, when XINB[11]=1, signal 1019 is output as 12 bits of “0,” which refers to the partial product of the subset including the most significant bit of the input data element XIN[11] and the weight data element W being equal to 0. When XINB[11]=0, signal 1019 is still output as 12 bits of “0,” which refers to the partial product of the subset including the most significant bit of the input data element XIN[11] and the weight data element W being equal to 0. In the current example, it is noted that each of the Booth decoders 1020A to 1020F receives signal 1007 (W) and signal 1009 (−W). Signals 1007 and 1009 can be presented as NOR(1,WB[11]), W[11:0] and WN[12],WN[12:0], respectively, where NOR(1,WB[11]), W[11:0] represents appending “0” bit(s) to the left-hand side of the most significant bit of the weight data element, W[11:0].

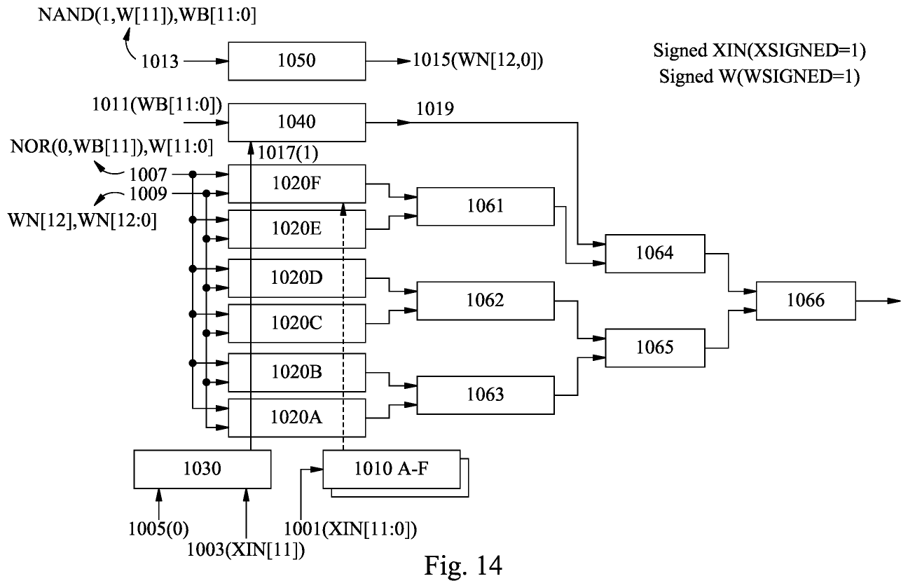

In FIG. 14, an example where the input data element XIN is provided as signed and the weight data element W is provided as signed (i.e., XSIGNED=1 and WSIGNED=1) is illustrated. As such, signal 1005, XSIGNEDB=0, which causes the logic component 1030 to output signal 1017 as logic 1, by NAND'ing 0 and XIN[11]. In response, the logic component 1040 outputs signal 1019 as having all “0,” by NOR'ing “1” and WB[11:0], regardless of XINB[11] being equal to logic 1 or 0. For example, when XINB[11]=1, signal 1019 is output as 12 bits of “0,” which refers to the partial product of the subset including the most significant bit of the input data element XIN[11] and the weight data element W being equal to 0. When XINB[11]=0, signal 1019 is still output as 12 bits of “0,” which refers to the partial product of the subset including the most significant bit of the input data element XIN[11] and the weight data element W being equal to 0. In the current example, it is noted that each of the Booth decoders 1020A to 1020F receives signal 1007 (W) and signal 1009 (−W). Signals 1007 and 1009 can be presented as NOR(0, WB[11]), W[11:0] and WN[12], WN[12:0], respectively, where NOR(1,WB[11]), W[11:0] represents appending additional most significant bit(s) to the left-hand side of the most significant bit of the weight data element, W[11:0].

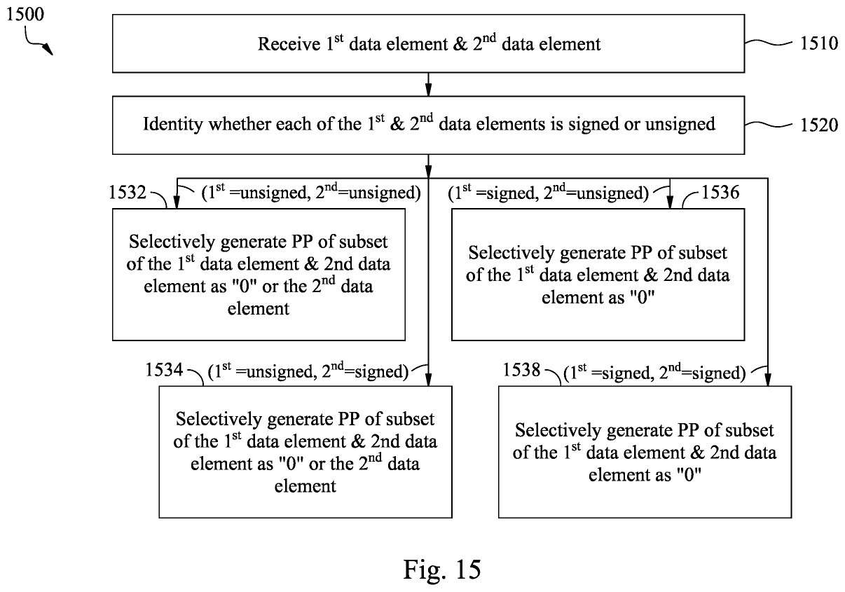

FIG. 15 illustrates a flow chart of an example method 1500 for performing MAC operations on an input data element XIN and a weight data element W, in accordance with various embodiments of the present disclosure. In some embodiments, the input data element XIN and the weight data element W can each be provided as a signed or unsigned data element. The operations of the method 1500 may be performed by the components described above in, e.g., FIGS. 10-14, and thus, some of the reference numerals used above may be re-used the following discussion of the method 1500. Further, it is understood that the method 1500 has been simplified, and thus, additional operations may be provided before, during, and after the method 1500 of FIG. 15, and that some other operations may only be briefly described herein.

The method 1500 starts with operation 1510 of receiving a first data element and a second data element. The first data element may be an input data element XIN, and the second data element may be a weight data element W. Using the computation circuit 1000 of FIG. 10 as a non-limiting example where the input data element XIN and the weight data element W each have 12 bits, the Booth encoders 1010A to 1010F can respectively receive subsets of the input data element XIN (or signal 1001, e.g., XIN[11:0]), and the Booth decoders 1020A to 1020F can receive the weight data element W (or signal 1007, e.g., W[11:0]) and its inversed version −W (or signal 1009).

The method 1500 proceeds to operation 1520 of identifying whether the first data element is signed or unsigned and whether the second data element is signed or unsigned. In some embodiments, the input data element XIN and weight data element W may be received as one of the following combinations: an unsigned input data element and an unsigned weight data element; an unsigned input data element and a signed weight data element; a signed input data element and an unsigned weight data element; and a signed input data element and a signed weight data element. The signed/unsigned input data element may be indicted by XSIGNED, and the signed/unsigned weight data element may be indicated by WSIGNED. For example, whether the input data element is signed or unsigned can be identified by the XSIGNED, and whether weight data element is signed or unsigned can be identified by the WSIGNED.

Upon identifying whether each of the input data element XIN and weight data element W is signed or unsigned (operation 1520), the method 1500 can proceed to one of the following operations 1532, 1534, 1536, and 1538. Each of the operations 1532 to 1538 will be discussed in further detail as follows.

Operation 1532 includes selectively generating a partial product of a subset of the first data element having the most significant bit of the first data element and the second data element that is either equal to “0” or just the second data element, in response to identifying that the first data element is unsigned and the second data element is unsigned. Continuing with the same example, upon identifying that input data element XIN is unsigned and weight data element W is unsigned (e.g., XSIGNED=0 and WSIGNED=0), the logic component 1030 (e.g., a NAND2 gate), with its inputs provided as XSIGNEDB and XIN[11], respectively, can output signal 1017 representing XINB[11], which causes the logic component 1040 (e.g., a NOR2 gate) to output signal 1019 as having its all bits equal to “0” or equal to the weight data element, W[11:0]. In various embodiments, signal 1019 can represent the partial product of a subset of the input data element that includes its most significant bit and the weight data element.

Further, operation 1532 includes providing each of the Booth decoders 1020A to 1020F with one input (signal 1007) operatively equal to W and the other input (signal 1009) operatively equal to −W. In some embodiments, the computation circuit 1000 can generate signal 1007 using another NOR. In operation 1532 (where WSIGNEDB=1), signal 1007 can be generated as NOR(1,WB[11]), W[11:0], which is equal to 0, W[11:0]. As such, at least one “0” bit is appended to the left-hand side of the weight data element W[11:0]. Signal 1009 can be

generated as WN[12], WN[12:0], where WN[12:0] is signal 1015. The computation circuit 1000 can first generate signal 1015 using another NAND and the logic component 1050 (e.g., a half adder). In operation 1532 (where WSIGNED=0), signal 1015 (WN[12:0]) can be generated as one bit added to NAND(0,W[11]), WB[11:0], which is equal to 1, WB[11:0].

Operation 1534 includes selectively generating a partial product of a subset of the first data element having the most significant bit of the first data element and the second data element that is either equal to “0” or just the second data element, in response to identifying that the first data element is unsigned and the second data element is signed. Continuing with the same example, upon identifying that input data element XIN is unsigned and weight data element W is signed (e.g., XSIGNED=0 and WSIGNED=1), the logic component 1030 (e.g., a NAND2 gate), with its inputs provided as XSIGNEDB and XIN[11], respectively, can output signal 1017 representing XINB[11], which causes the logic component 1040 (e.g., a NOR2 gate) to output signal 1019 as having its all bits equal to “0” or equal to the weight data element, W[11:0]. In various embodiments, signal 1019 can represent the partial product of a subset of the input data element that includes its most significant bit and the weight data element.

Further, operation 1534 includes providing each of the Booth decoders 1020A to 1020F with one input (signal 1007) operatively equal to W and the other input (signal 1009) operatively equal to −W. In some embodiments, the computation circuit 1000 can generate signal 1007 using another NOR. In operation 1534 (where WSIGNEDB=0), signal 1007 can be generated as NOR(0,WB[11]), W[11:0], which is equal to W[11], W[11:0]. As such, at least one most significant bit is appended to the left-hand side of the weight data element W[11:0]. Signal 1009 can be generated as WN[12],WN[12:0], where WN[12:0] is signal 1015. The computation circuit 1000 can first generate signal 1015 using another NAND and the logic component 1050 (e.g., a half adder). In operation 1534 (where WSIGNED=1), signal 1015 (WN[12:0]) can be generated as one bit added to NAND(1,W[11]), WB[11:0], which is equal to WB[11], WB[11:0].

Operation 1536 includes generating a partial product of a subset of the first data element having the most significant bit of the first data element and the second data element that is equal to “0,” in response to identifying that the first data element is signed and the second data element is unsigned. Continuing with the same example, upon identifying that input data element XIN is signed and weight data element W is unsigned (e.g., XSIGNED=1 and WSIGNED=0), the logic component 1030 (e.g., a NAND2 gate), with its inputs provided as XSIGNEDB and XIN[11], respectively, can output signal 1017 as “1,” which causes the logic component 1040 (e.g., a NOR2 gate) to output signal 1019 as having its all bits equal to “0.” In various embodiments, signal 1019 can represent the partial product of a subset of the input data element that includes its most significant bit and the weight data element.

Further, operation 1536 includes providing each of the Booth decoders 1020A to 1020F with one input (signal 1007) operatively equal to W and the other input (signal 1009) operatively equal to −W. In some embodiments, the computation circuit 1000 can generate signal 1007 using another NOR. In operation 1532 (where WSIGNEDB=1), signal 1007 can be generated as NOR(1,WB[11]), W[11:0], which is equal to 0,W[11:0]. As such, at least one “0” bit is appended to the left-hand side of the weight data element W[11:0]. Signal 1009 can be generated as WN[12], WN[12:0], where WN[12:0] is signal 1015. The computation circuit 1000 can first generate signal 1015 using another NAND and the logic component 1050 (e.g., a half adder). In operation 1532 (where WSIGNED=0), signal 1015 (WN[12:0]) can be generated as one bit added to NAND(0, W[11]), WB[11:0], which is equal to 1, WB[11:0].

Operation 1538 includes generating a partial product of a subset of the first data element having the most significant bit of the first data element and the second data element that is equal to “0,” in response to identifying that the first data element is signed and the second data element is signed. Continuing with the same example, upon identifying that input data element XIN is signed and weight data element W is signed (e.g., XSIGNED=1 and WSIGNED=1), the logic component 1030 (e.g., a NAND2 gate), with its inputs provided as XSIGNEDB and XIN[11], respectively, can output signal 1017 as “1,” which causes the logic component 1040 (e.g., a NOR2 gate) to output signal 1019 as having its all bits equal to “0.” In various embodiments, signal 1019 can represent the partial product of a subset of the input data element that includes its most significant bit and the weight data element.

Further, operation 1538 includes providing each of the Booth decoders 1020A to 1020F with one input (signal 1007) operatively equal to W and the other input (signal 1009) operatively equal to −W. In some embodiments, the computation circuit 1000 can generate signal 1007 using another NOR. In operation 1538 (where WSIGNEDB=0), signal 1007 can be generated as NOR(0,WB[11]), W[11:0], which is equal to W[11],W[11:0]. As such, at least one most significant bit is appended to the left-hand side of the weight data element W[11:0]. Signal 1009 can be generated as WN[12], WN[12:0], where WN[12:0] is signal 1015. The computation circuit 1000 can first generate signal 1015 using another NAND and the logic component 1050 (e.g., a half adder). In operation 1538 (where WSIGNED=1), signal 1015 (WN[12:0]) can be generated as one bit added to NAND(1, W[11]), WB[11:0], which is equal to WB[11], WB[11:0].

Concurrently with or subsequently to any of operations 1532 to 1538, the method 1500 can further include one or more operations (not shown in FIG. 15 for brevity purposes) to sum up all the partial products generated by the Booth decoders (e.g., Booth decoders 1020A to 1020F). Next, the adder tree 1060 of the computation circuit 1000 can sum up these partial products to generate a final product of the input data element XIN and weight data element W.

FIG. 16 illustrate an example of a computation circuit 1600 processing signed or unsinged input data element XIN and signed or unsinged weight data element W. The computation circuit 1600 is substantially similar to computation circuit 1000 of FIG. 10. In the example of FIG. 16, each of the input data element XIN and weight data element W is provided with k bits. As such, a number of Booth encoders and a number Booth decoders of the computation circuit 1600 may vary accordingly. For example, the computation circuit 1600 can include k/2 Booth encoders 1610 and k/2 Booth decoders 1620. Further, the computation circuit 1600 can include other components substantially similar to the components shown in FIG. 10. For example, the computation circuit 1600 also includes a NAND2 gate 1630, a NOR2 gate 1640, a half adder 1650, and a number of full adders, 1661, 1662, 1663, 1664, 1665, and 1666. With the data element provided with k bits, corresponding bits of the signals received or otherwise processed by the computation circuit 1600 can vary accordingly. Such signals (1601, 1603, 1605, 1607, 1609, 1611, 1613, 1615, 1619) are each represented in the form illustrated in FIG. 16. Signals 1601 to 1619 are substantially similar to signals 1001 to 1019 (FIG. 10), and thus, the corresponding discussion is not repeated.

FIG. 17 illustrates an example circuit diagram 1700 of a Booth encoder (e.g., 210 of FIG. 2, 300 of FIG. 3, 510 of FIG. 5, 1010A-F of FIGS. 10-14), in accordance with various embodiments of the present disclosure. Hereinafter, the circuit diagram of FIG. 17 is referred to as Booth encoder 1700. It should be understood that that the circuit diagram of FIG. 17 is a non-limiting implementation of the Booth encoder, and does not intend to limit the scope of the present disclosure.

In some embodiments, the Booth encoder 1700 can implement 3-bit Booth encoding on a 3-bit subset of a data element (e.g., X²ⁱ⁺¹, X₂ᵢ, and X₂ᵢ₋₁). As shown, a first input bit line carrying a first signal representing a first bit of the subset (e.g., X₂ᵢ₋₁) and a second input bit line carrying a second signal representing a second bit of the subset (e.g., X₂ᵢ) may be coupled to an input end of an exclusive OR (“XOR”) gate 1702. The XOR gate 1702 may receive the first signal and the second signal as inputs, and generate an output as a first intermediary signal (“1x”). The second bit line and a third bit line carrying a third signal representing a third bit of the subset (e.g., X₂ᵢ₊₁) may be coupled to an input end of an exclusive NOR (“XNOR”) gate 1708. The XNOR gate 1708 may receive the second signal and the third signal as inputs, and generate an output as a second intermediary signal (“2x”).

A first NOR gate 1704 may be coupled to an output end of the XOR gate 1702 and an output end of the XNOR gate 1708 to receive as inputs to the first NOR gate 1704. Thus, the first NOR gate 1704 may receive the first intermediary signal 1x from the XOR gate 1702 and the second intermediary signal 2x from the XNOR gate 1708 as inputs. The first NOR gate 1704 may generate an output as a Booth encoded bit (“BE”).

A second NOR gate 1706 may be coupled to the output end of the XOR gate 1702 to receive the first intermediary signal 1x as an input as well as an output end of the first NOR gate 1704 to receive the Booth encoded bit BE as inputs to the second NOR gate 1706. Thus, the second NOR gate 1706 may receive the first intermediary signal 1x from the XOR gate 1702 and the Booth encoded bit BE from the first NOR gate 1704 as inputs. The second NOR gate 1706 may generate an output as an enable bit (“ENB”).

A third NOR gate 1710 may be coupled to an output end of the second NOR gate 1706 at an input end of the third NOR gate 1710 to receive the ENB as an input. The third NOR gate 1710 may also be coupled to the third bit line at an inverted input end to receive the inverse of the third bit line as an input. For example, an inverted may be coupled between the third bit line and the input end of the third NOR gate 1710. Thus, the third NOR gate 1710 may receive the enable bit ENB from the second NOR gate 1706 and the third signal representing an inverse of the third bit of the subset from the third bit line as inputs. In some embodiments the third NOR gate 1710 may invert the third signal. In some embodiment, the third NOR gate 1710 may receive an inverted third signal from the inverter. The third NOR gate 1710 may generate an output as a select bit (“S”).

FIG. 18 illustrates an example circuit diagram of a Booth decoder (e.g., 220 of FIG. 2, 520 of FIG. 5, 1020A-F of FIGS. 10-14), in accordance with various embodiments of the present disclosure. Hereinafter, the circuit diagram of FIG. 18 is referred to as Booth decoder 1800. It should be understood that that the circuit diagram of FIG. 18 is a non-limiting implementation of the Booth decoder, and does not intend to limit the scope of the present disclosure.

In some embodiments, the Booth decoder 1800 can be operatively coupled to a corresponding 3-bit Booth encoder (e.g., Booth encoder 1700) to receive Booth encoded signals, e.g., a Booth encoded bit (BE), an enable bit (ENB), and a select bit(S). As shown, the Booth decoder 1800 include a multiplexer 1810 and an adder 1850.

The multiplexer 1810 may be coupled, at an input, to any number of input lines configured to carry a weight data element. For example, the multiplexer 1810 may be coupled to four input lines configured to carry a 4-bit weight data element (e.g., W[3], W[2], W[1], W[0]). The multiplexer 1810 may include multiple inverters 1812 and 1814, which may be configured to function as buffers for temporary storage of the weight data element. For example, one of the inverters 1812 may be configured to temporarily store the weight data element, and a corresponding one of the inverters 1814 may be configured to temporarily store the inverse of the weight data element.

The multiplexer 1810 may be coupled, at a select line, to a select signal (e.g., select bit “S”) output by the corresponding Booth encoder. The multiplexer 1810 may include multiple transmission gates 1816 coupled between the inverters 1812, 1814 and outputs of the multiplexer 1810. The transmission gates 1816 may also be coupled, at an input, to the select signal. The select signal may determine which of the input signal or the inverse of the input signal of each of the input weight data element (e.g., W[3], W[2], W[1], W[0]) to output from the multiplexer 1810. In some embodiments, pairs of the transmission gates 1816, coupled to the same output of the multiplexer 1810 may be differently configured to respond to the select signal. For example, a transmission gate 1810 may enable transmission of the weight data and/or inverse of the weight data element stored at the inverter 1812 and another transmission gate 1816 may prevent transmission of the weight data element and/or inverse of the weight data element stored at the inverter 1814 for the same select signal, and vice versa. The multiplexer 1810 may output weight data element and/or inverse of the weight data element at an output as controlled by the select signal.

The adder 1850 may receive, at an input, the weight data and/or inverse of the weight data element (collectively referred to herein as weight data element for the adder 1850) output by the multiplexer 1810. The adder 1850 may be coupled to an enable signal (e.g., enable bit “ENB”) that may be outputted from the corresponding Booth encoder. The enable signal may trigger the adder 1850 to add the signal received at the inputs to a value held in an adder component 1870 (e.g., a shift register). The adder 1850 may include multiple NOR gates 1852A, 1852B, and 1852C configured to receive the weight data element at one input and the enable signal at a second input of the NOR gates 1852A-C. The NOR gates 1852A-C may be configured to NOR the weight data element and the enable signal such that the enable signal may control a logic gating operation of the adder 1850. For example, an enable signal configured to enable logic gating (e.g., enable signal is a “1” value), the NOR gates 1852A-C may only output “0” values regardless of the value of the weight data. Otherwise, the NOR gates 1852A-C may output the weight data at the input and the enable signal configured not to enable logic gating (e.g., enable signal is a “0” value).

A control of the adder 1850 may be coupled to a Booth encoded bit (e.g., Booth encoded bit “BE”) that is output by the corresponding Booth encoder. The Booth encoded bit may be configured to control whether the adder 850 executes a shift left operation (e.g., shift left 1 bit). The output of each NOR gate 1852A-C may be coupled to a shifter 1856. The shifter 1856 may include multiple transmission gates 1858 configured to couple the output of each NOR gate to multiple inverters 1860. In addition, the shifter 1856 may be configured to directly couple an inverter 1862 to the output of the NOR gate 1852A and may include one of the transmission gates 1858 configured to couple the output of the NOR gate 1852A to one of the inverters 1860. The NOR gate 1852A may be associated with an input of the most significant bit of the weight data element. The inverter 1860 coupled to the NOR gate 1852A may correspond with a most significant bit position of the weight data element, and the inverter 1862 coupled to the NOR gate 1852A may correspond with a more significant bit position that the most significant bit position of the weight data element. The shifter 1856 may include another of the transmission gates 1858 configured to couple the output of the NOR gate 1852C to one of the inverters 1860 and yet another of the transmission gate 1858 configured to couple the output of the NOR gate 1852C to an inverter 1864. The NOR gate 1852C may be associated with an input of the least significant bit of the weight data element. The inverter 1864 coupled to the NOR gate 1852C may correspond with a least significant bit position of the weight data element. The adder 1850 may also be coupled to a supply voltage (VDD). The shifter 1856 may include a transmission gate 1866 configured to couple the supply voltage VDD to the inverter 1864.

The transmission gates 1858 and 1866 may also be coupled to the Booth encoded (BE) bit. The transmission gates 1858 may be configured to enable and/or prevent transmission of the output from the NOR gates 1852A-C to the inverters 1860 and 1864. The transmission gate 1866 may be configured to enable and/or prevent transmission of the supply voltage to the inverter 1864. In some embodiments, pairs of the transmission gates 1858, 1866, coupled to the same inverters 1860, 1864 may be differently configured to respond to the Booth encoded bit.

In one aspect of the present disclosure, a memory circuit is disclosed. The memory circuit includes a Booth encoder configured to receive a first data element including a first sign portion and a first data portion. The memory circuit includes a Booth decoder configured to receive a second data element including a second sign portion and a second data portion, and provide a product based on the first data element and the second data element. The memory circuit includes a plurality of multiplexers operatively coupled between the Booth encoder and the Booth decoder. The plurality of multiplexers are configured to receive a plurality of encoded signals from the Booth encoder and to change respective logic states of the plurality of encoded signals based on the first sign portion and the second sign portion, causing the Booth decoder to provide the product.

In another aspect of the present disclosure, a memory circuit is disclosed. The memory circuit includes a memory array. The memory circuit includes a computation circuit coupled to the memory array. The computation circuit comprises: a Booth encoder configured to receive a first data element including a first sign bit and a plurality of first data bits, and configured to provide a plurality of encoded values based on the plurality of first data bits; a Booth decoder configured to retrieve, from the memory array, a second data element including a second sign bit and a plurality of second data bits, and provide a plurality of partial products based on multiplying the first data element by the second data element; and a plurality of multiplexers operatively coupled between the Booth encoder and the Booth decoder. The plurality of multiplexers are each configured to select, based on a logically processed signal of the first sign bit and the second sign bit, a first one of the encoded values or a second one of the encoded values.

In yet another aspect of the present disclosure, a method for operating a memory circuit is disclosed. The method includes receiving a first data element and a second data element, wherein the first data element includes a first sign bit and a plurality of first data bits, and the second data element includes a second sign bit and a plurality of second data bits. The method includes encoding the plurality of first data bits to generate a plurality of encoded values, wherein each of the encoded values corresponds to a respective combination of logic states of a subset of first data bits. The method includes selecting between a first one of the plurality of encoded values and a second one of the plurality of encoded values that are inverse to each other, based on a logically processed signal of the first sign bit and the second sign bit. The method includes multiplying the second data bits by the selected first encoded value or second encoded value.

As used herein, the terms “about” and “approximately” generally indicates the value of a given quantity that can vary based on a particular technology node associated with the subject semiconductor device. Based on the particular technology node, the term “about” can indicate a value of a given quantity that varies within, for example, 10-30% of the value (e.g., ±10%, ±20%, or ±30% of the value).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A memory circuit, comprising:
a Booth encoder configured to receive a first data element including a first sign portion and a first data portion;
a Booth decoder configured to receive a second data element including a second sign portion and a second data portion, and provide a product based on the first data element and the second data element; and
a plurality of multiplexers operatively coupled between the Booth encoder and the Booth decoder;
wherein the plurality of multiplexers are configured to receive a plurality of encoded signals from the Booth encoder and to change respective logic states of the plurality of encoded signals based on the first sign portion and the second sign portion, causing the Booth decoder to provide the product.

2. The memory circuit of claim 1, wherein each of the multiplexers is controlled by an XOR'ed signal of the first sign portion and the second sign portion.

3. The memory circuit of claim 1, wherein each of the multiplexers has a first input and a second input configured to receive a first combination of the logic states of the encoded signals and a second combination of the logic states of the encoded signals, respectively.

4. The memory circuit of claim 3, wherein the first combination corresponds to a first encoded value by which the first data portion is multiplied, and the second combination of the encoded signals correspond to a second encoded value by which the second data portion is multiplied.

5. The memory circuit of claim 4, wherein the first encoded value and the second encoded value are inverse to each other.

6. The memory circuit of claim 3, wherein each of the multiplexers is configured to select the first combination, in response to receiving an XOR'ed signal of the first sign portion and the second sign portion being equal to a first logic state.

7. The memory circuit of claim 6, wherein each of the multiplexers is configured to select the second combination, in response to receiving the XOR'ed signal of the first sign portion and the second sign portion being equal to a second logic state.

8. The memory circuit of claim 1, wherein a number of the multiplexers corresponds to a number of the first data portion.

9. The memory circuit of claim 1, wherein the first data element represents a plurality of input activations received by a memory array, and the second data element represents a plurality of weights stored in the memory array.

10. The memory circuit of claim 1, wherein the first data portion represents a plurality of first mantissa bits of the first signal, and the second data portion represents a plurality of second mantissa bits of the second signal.

11. A memory circuit, comprising:
a memory array; and
a computation circuit coupled to the memory array, wherein the computation circuit comprises:
a Booth encoder configured to receive a first data element including a first sign bit and a plurality of first data bits, and configured to provide a plurality of encoded values based on the plurality of first data bits;
a Booth decoder configured to retrieve, from the memory array, a second data element including a second sign bit and a plurality of second data bits, and provide a plurality of partial products based on multiplying the first data element by the second data element; and
a plurality of multiplexers operatively coupled between the Booth encoder and the Booth decoder, wherein the plurality of multiplexers are each configured to select, based on a logically processed signal of the first sign bit and the second sign bit, a first one of the encoded values or a second one of the encoded values.

12. The memory circuit of claim 11, wherein the Booth decoder is further configured to multiply the second data element by the selected first or second encoded value for a corresponding one of the plurality of partial products.

13. The memory circuit of claim 11, wherein a first one of the multiplexers is configured to:
(i) select a first one of the encoded values corresponding to a first combination of logic states of a subset of the first data bits, upon identifying that an XOR'ed signal of the first sign bit and the second sign bit is equal to a logic 0; and
(ii) select a second one of the encoded values corresponding to a second combination of the logic states of the subset of first data bits, upon identifying that the XOR'ed signal of the first sign bit and the second sign bit is equal to a logic 1.

14. The memory circuit of claim 13, wherein a second one of the multiplexers is configured to:
(i) select the second encoded value, upon identifying that an XOR'ed signal of the first sign bit and the second sign bit is equal to a logic 0; and
(ii) select the first encoded value, upon identifying that the XOR'ed signal of the first sign bit and the second sign bit is equal to a logic 1.

15. The memory circuit of claim 14, wherein a third one of the multiplexers is configured to:
(i) select a third one of the encoded values corresponding to a third combination of the logic states of the subset of the first data bits, upon identifying that an XOR'ed signal of the first sign bit and the second sign bit is equal to a logic 0; and
(ii) select a fourth one of the encoded values corresponding to a fourth combination of the logic states of the subset of the first data bits, upon identifying that the XOR'ed signal of the first sign bit and the second sign bit is equal to a logic 1.

16. The memory circuit of claim 15, wherein a third one of the multiplexers is configured to:
(i) select the fourth encoded value, upon identifying that an XOR'ed signal of the first sign bit and the second sign bit is equal to a logic 0; and
(ii) select the third encoded value, upon identifying that the XOR'ed signal of the first sign bit and the second sign bit is equal to a logic 1.

17. The memory circuit of claim 11, wherein a number of the multiplexers corresponds to a number of the first data bits.

18. The memory circuit of claim 11, wherein the first data bits represent a plurality of first mantissa bits of the first data element, and the second data bits represent a plurality of second mantissa bits of the second data element.

19. A method, comprising:
receiving a first data element and a second data element, wherein the first data element includes a first sign bit and a plurality of first data bits, and the second data element includes a second sign bit and a plurality of second data bits;
encoding the plurality of first data bits to generate a plurality of encoded values, wherein each of the encoded values corresponds to a respective combination of logic states of a subset of first data bits;
selecting between a first one of the plurality of encoded values and a second one of the plurality of encoded values that are inverse to each other, based on a logically processed signal of the first sign bit and the second sign bit; and
multiplying the second data bits by the selected first encoded value or second encoded value.

20. The method of claim 19, wherein the first data bits represent a plurality of first mantissa bits of the first data element, and the second data bits represent a plurality of second mantissa bits of the second data element.
